(19) United States
(12) Patent Application Publication
(10) Pub. No.: US 2023/0205186 A1
(43) Pub. Date: Jun. 29, 2023

(54) BRICK MAKING SYSTEM, PRODUCTION CONTROL METHOD, DEVICE, SYSTEM, PRODUCTION EQUIPMENT, AND MEDIUM

(71) Applicant: GUANGDONG BRIGHT DREAM ROBOTICS CO., LTD., Foshan, Guangdong (CN)

(72) Inventors: Xuejiao ZHOU, Foshan (CN); Xu LI, Foshan (CN); Shuan ZHAO, Foshan (CN); Kaiguo XU, Foshan (CN)

(21) Appl. No.: 17/999,821

(22) PCT Filed: Nov. 23, 2021
(86) PCT No.: PCT/CN2021/132336

§ 371 Date: Nov. 23, 2022

(30) Foreign Application Priority Data
Nov. 26, 2020 (CN) 202011346024.4
Jan. 28, 2021 (CN) 202110119488.X
Mar. 17, 2021 (CN) 202120545227.X

(51) Int. Cl. G05B 19/418

(52) U.S. Cl. CPC G05B 19/41835; G05B 2219/45086

(57) ABSTRACT

The present disclosure relates to a brick making system, a production control method, a production control device, a production system, a production equipment, and a computer-readable record medium. The brick making system includes: a brick making machine; a bottom material distribution device connected to one side of the brick making machine to feed bottom material to the brick making machine in a first direction; and a surface material distribution device connected to the other side of the brick making machine adjacent to the one side, to feed surface material to the brick making machine in a second direction. The bottom material distribution device and the surface material distribution device are arranged at adjacent two sides of brick making machine, respectively, so that the occupied space of the brick making system can be reduced.

### CROSS REFERENCE TO RELATED APPLICATIONS

This application claims priority to Chinese Patent Application No. 202011346024.4. entitled “BRICK MAKING EQUIPMENT”, filed on Nov. 26, 2020, Chinese Patent Application No. 202110119488.X, entitled “PRODUCTION CONTROL METHOD, DEVICE, SYSTEM, PRODUCTION EQUIPMENT, AND MEDIUM”, filed on Jan. 28, 2021, and Chinese Patent Application No. 202120545227,X, entitled “INTEGRATED MACHINE FOR CRUSHING AND BRICK MAKING AND MOVABLE VEHICLE FOR CONSTRUCTION WASTE CRUSHING AND BRICK MAKING”, filed on Mar. 17, 2021, the contents of which are incorporated herein by reference in their entireties.

### TECHNICAL FIELD

The present disclosure relates to the technical field of construction equipment, and in particular, to a brick making system, a production control method, a production control device, a production system, a production equipment, and a computer-readable storage medium.

### BACKGROUND

At present, the resource recycling and utilization of construction waste, tailings, slag, silt, etc. are all treated in various ways according to types and characteristics of solid wastes. Recycled products obtained after treatment can be further processed into concrete products, such as bricks, according to types of the recycled products to realize the secondary utilization of the solid wastes. A production line of concrete products has a low automation, and manual participation is often required in the transportation of raw materials and finished products, resulting in high transportation costs.

At present, in real estate construction projects, old building reconstruction or demolition projects, the construction wastes are generally treated in a centralized manner, that is, firstly, the construction wastes are sorted and crushed into recycled aggregates for recycling and being put into the building material market to be used in the production lines of concrete products again. With this treatment method, various traction equipment and vehicles are needed for auxiliary construction, and manual participation is required for treatment, and thus, the economic benefit is low. Especially in the real estate projects under construction, due to the small amount of construction waste and the long cycle span, it is easy to cause idle equipment and manpower. In addition, the need for changing the site is frequent, which greatly increases the cost of recycling the construction waste.

In addition, various equipment in a common brick-making production line for treating the construction waste are usually arranged in one direction and connected in sequence, which not only occupies a large area, but also needs to be provided with multiple auxiliary equipment. Once the brick-making production line is mounted and fixed, it is costly to relocate its mounting site again, resulting in poor use flexibility of the brick-making production line. Moreover, the brick-making production line with the various equipment arranged in one direction can only carry out single-side distribution, pallet feeding, and pallet discharging, resulting in a long brick making cycle and low production efficiency.

A Chinese patent document CN211541646U discloses a movable integrated machine for crushing and brick making, which adopts crushing equipment and brick making equipment respectively arranged in a compartment of a movable vehicle to realize continuous operation of crushing the construction waste and making bricks. However, the arrangements of the crushing equipment, the brick making equipment, and other accessory equipment in the compartment results in the length of the vehicle being too long, which is not beneficial to the turning of the vehicle.

### SUMMARY

According to a first aspect of the present disclosure, a production control method applied in a production system is provided. The production system includes at least two robots with different production functions. The production control method includes: obtaining an initial position of each of the robots and a target position in a production process of each of the robots; and planning a working path of each of the robots according to the initial position and the target position of each of the robots, and respectively controlling a corresponding robot to work based on a working sequence and the working path of each of the robots.

According to a second aspect of the present disclosure, a production control device applied in a production system is provided. The production system includes at least two robots with different production functions. The production control device includes: a position obtaining module configured to obtain an initial position of each of the robots and a target position in a production process of each of the robots; and a path planning module configured to plan a working path of each of the robots according to the initial position and the target position of each of the robots, and respectively control a corresponding robot to work based on a working sequence, and the working path of each of the robots.

According to a third aspect of the present disclosure, a production equipment is provided. The production equipment includes: one or more processors; and a storage device configured to store one or more programs. The one or more processors are configured to perform the one or more programs to implement the production control method as described above.

According to a fourth aspect of the present disclosure, a brick making system is provided. The brick making system includes: a brick making machine; a bottom material distribution device connected to one side of the brick making machine to feed bottom material to the brick making machine in a first direction; and a surface material distribution device connected to the other side of the brick making machine adjacent to the one side, to feed surface material to the brick making machine in a second direction.

According to a fifth aspect of the present disclosure, a computer-readable storage medium is provided. A computer program is stored on the computer-readable storage medium. When the program is executed by a processor, the production control method described according to the first aspect is implemented.

### BRIEF DESCRIPTION OF THE DRAWINGS

In order to more clearly illustrate technical solutions in the embodiments of the present disclosure or related arts, the accompanying drawings that are required to be used in the description of the embodiments or related arts will be briefly introduced below. Apparently, the drawings in the following description are only some embodiments of the present disclosure, and for those of ordinary skill in the art, other drawings can also be derived from these drawings without creative effort.

FIG. 1 is a flowchart of a production control method according to an embodiment of the present disclosure.

FIG. 2 is a flowchart of a production control method according to an embodiment of the present disclosure.

FIGS. 3A and 3B are schematic flowcharts of a production control method according to an embodiment of the present disclosure.

FIG. 4 is a diagram showing a structure of a production control device according to an embodiment of the present disclosure.

FIG. 5 is a schematic diagram showing a structure of a production system according to an embodiment of the present disclosure.

FIG. 6 is a schematic diagram showing a structure of a production equipment according to an embodiment of the present disclosure.

FIG. 7 is a front view of a brick making system according to an embodiment of the present disclosure.

FIG. 8 is a side view of the brick making system shown in FIG. 7 according to the embodiment of the present disclosure.

FIG. 9 is a top view of the brick making system shown in FIG. 7 according to the embodiment of the present disclosure.

FIG. 10 is a front view of a first feeding device (longitudinal pallet feeding vehicle) in the brick making system shown in FIG. 7 according to the embodiment of the present disclosure.

FIG. 11 is a side view of the first feeding device (longitudinal pallet feeding vehicle) in the brick making system shown in FIG. 10 according to the embodiment of the present disclosure.

FIG. 12 is a top view of the first feeding device (longitudinal pallet feeding vehicle) in the brick making system shown in FIG. 10 according to the embodiment of the present disclosure.

FIG. 13 is a front view of a second feeding device/surface material distribution device (transverse pallet feeding vehicle/surface material distribution vehicle) in the brick making system shown in FIG. 7 according to an embodiment of the present disclosure.

FIG. 14 is a side view of the second feeding device/surface material distribution device (transverse pallet feeding vehicle/surface material distribution vehicle) in the brick making system shown in FIG. 13 according to the embodiment of the present disclosure.

FIG. 15 is a top view of the second feeding device/surface material distribution device (transverse pallet feeding vehicle/surface material distribution vehicle) in the brick making system shown in FIG. 14 according to the embodiment of the present disclosure.

FIG. 16 is a front view of a brick making machine in the brick making system shown in FIG. 7 according to the embodiment of the present disclosure.

FIG. 17 is a side view of the brick making machine in the brick making system shown in FIG. 16 according to the embodiment of the present disclosure.

FIG. 18 is a top view of the brick making machine in the brick making system shown in FIG. 16 according to the embodiment of the present disclosure.

FIG. 19 is a front view of a special tooling for mold the brick making system shown in FIG. 7 according to the embodiment of the present disclosure.

FIG. 20 is a top view of the special tooling for mold in the brick making system shown in FIG. 19 according to the embodiment of the present disclosure.

FIG. 21 is a front view of an integrated machine for crushing and brick making according to an embodiment of the present disclosure.

FIG. 22 is another front view of the integrated machine for crushing and brick making according to an embodiment of the present disclosure, showing a state in which a feeding belt shown in FIG. 21 is folded upward.

FIG. 23 is a top view of the integrated machine for crushing and brick making shown in FIG. 21 according to the embodiment of the present disclosure.

FIG. 24 is a top view of an area of a brick making machine shown in FIG. 21.

### DETAILED DESCRIPTION OF THE EMBODIMENTS

The present disclosure will be further described in detail below with reference to the accompanying drawings and embodiments. It should be understood that the specific embodiments described herein are only configured to explain the present disclosure, but not intended to limit the present disclosure. In addition, it should be noted that, for clarity and convenience of description, the accompanying drawings may only show some but not all structures related to the present disclosure.

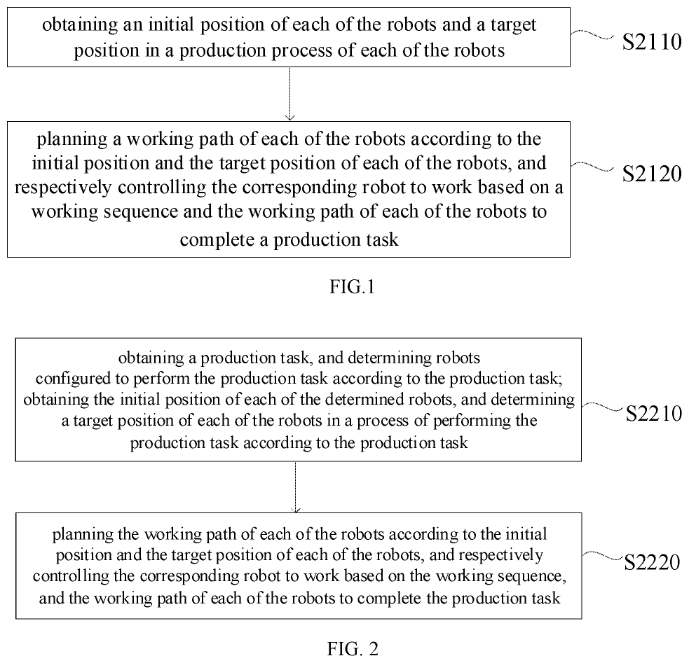

Embodiments of a production control method, a production control device, a production system, and a production equipment related to a brick-making production according to embodiments of the present disclosure will be described in detail below with reference to FIGS. 1 to 6.

FIG. 1 is a flowchart of a production control method according to an embodiment of the present disclosure. The method involved in this embodiment is suitable for collaborative production by robots with different functions, and the method can be performed by a production control device, and specifically includes the following steps.

At S2110, an initial position of each of the robots, and a target position in a production process of each of the robots are obtained.

Specifically, when producing products such as concrete products that require multiple processes or procedures, if the production efficiency needs to be improved, a plurality of robots with different production functions are required to cooperate to reduce manual participation and improve the degree of automation of a production line. When the plurality of robots with different production functions are controlled for production cooperation, it is necessary to obtain the initial position and the target position in the production process of each of the robots, so as to plan a working path of each of the robots through the initial position and the target position of each of the robots, thereby controlling each of the robots to move according to the corresponding working path, so as to carry out production work.

At S2120, the working path of each of the robots is planned according to the initial position and the target position of each of the robots, and the corresponding robot is respectively controlled to work based on a working sequence and the working path of each of the robots to complete a production task.

In order to complete the production task through the cooperation of each of the robots, the overall working sequence (hereinafter referred to as working sequence) of each of the robots with different production functions needs to be determined according to the sequence of the production processes of the product, and the working path of each of the robots needs to be planned according to the initial position and the target position of each of the robots. Then, based on the working sequence and the working path of each of the robots, the corresponding robots are respectively controlled to work.

Optionally, the respectively controlling the corresponding robots to work based on the working sequence and the working path of each of the robots includes: determining an initial working time of each of the robots based on the working sequence and a working duration of each of the robots; respectively controlling the corresponding robots to work based on the initial working time and the working path corresponding to the initial working time. The working sequence of each of the robots determines the sequence in which each of the robots starts to work. The initial working time of each of the robots can be determined through the working sequence and the working duration of each of the robots.

For example, a total of 3 robots with different functions are used for production work, namely a robot 1, a robot 2, and a robot 3, and the working sequence thereof is that the robot 1 starts to work first with a working duration of 1 hour, and then the robot 2 starts to work with a working duration of 30 minutes, and finally the robot 3 starts to work with a working duration of 20 minutes. In this example, the initial working time of the robot 1 is a preset initial working time. The robot 2 starts to work after the robot 1 works for 1 hour, and the robot 3 starts to work after the robot 2 works for 30 minutes. In general, each of the robots is respectively controlled to work according to the initial working time and the working path of each of the robots to complete the production task.

Optionally, the corresponding robots may also be respectively controlled to work based on the working sequence and the working path of each of the robots. The control method includes: in response to receiving work completion information of a robot in current procedure, sending a working path to a robot in next procedure to control the robot in the next procedure to start working. Alternatively, the control method includes: respectively sending each of the working paths to the corresponding robot in advance, and in response to receiving work completion information of the robot in current procedure, sending a work start instruction to the robot in next procedure. When controlling each of the robots to perform production work, the robot in the next procedure can also be activated to start working according to the work completion information of the current working robot. In an exemplary embodiment, in response to the robot A producing a green body, the working path is sent to the robot B in the next working sequence, and the robot B is controlled to start the work of transferring the green body according to the working path. In another exemplary embodiment, the planned working paths are respectively sent to the corresponding robots in advance. When the robot A produces a green body, information of completing the production of the green body is reported to a server. When receiving the information of completing the production of the green body sent by the robot A, the server sends a work start instruction to the robot B in the next procedure, and the robot B starts to move according to the working path to perform transferring work of the green body.

The production control method according to this embodiment can be applied to a production system, which includes at least two robots with different production functions. In this method, the initial position and the target position in the production process of each of the robots are obtained; the working path of each of the robots is planned according to the initial position and the target position of each of the robots, and the corresponding robot is controlled to work based on the working sequence and the working path of each of the robots to complete the production task. In this way, the problem of low degree of automation of the production line is solved, and the effects of reducing labor cost and improving production efficiency are realized.

FIG. 2 is a flowchart of a production control method according to an embodiment of the present disclosure. Steps of obtaining the initial position and the target position in the production process of each of the robots are further described in detail in this embodiment based on the previous embodiment. Specifically, the obtaining the initial position and the target position in the production process of each of the robots may include: obtaining a production task, and determining robots configured to perform the production task according to the production task; obtaining the initial position of each of the determined robots, and prior to performing the production task, determining a target position of each of the robots (here, namely, each of the robots configured to perform the production task) according to the production task. The robots configured to complete the production task are determined, and the initial position and the target position in the process of performing the production task of each of the determined robots are obtained in a targeted or selective manner, without obtaining position information of other robots that do not participate in the current production task, which helps to improve the efficiency of information obtaining, thereby improving path planning efficiency and production efficiency.

As shown in FIG. 2, the production control method specifically includes the following steps.

At S2210, a production task is obtained, and robots configured to perform the production task are determined according to the production task. The initial position of each of the determined robots is obtained, and the target position of each of the determined robots in the process of performing the production task is determined according to the production task.

The robot required for completing the production task is determined according to a predetermined production task, and the initial position and the target position in performing the production task of the robot for completing the production task are determined. In an embodiment, the production task is to produce a preset number of green bodies, and transfer the produced green bodies to a preset position. The robots for completing the production task include: a feeding robot configured to convey raw materials to a production line robot; the production line robot configured to obtain graded aggregate and other raw materials conveyed by the feeding robot to produce the green body; a transfer robot configured to transfer the green body from the production line robot to the preset position. Accordingly, the initial positions of the production line robot, the feeding robot, and the transfer robot are obtained, and the target positions in the process of performing production are determined according to the respective production tasks of the production line robot, the feeding robot, and the transfer robot. Exemplarily, the production line robot needs to obtain the graded aggregate from a graded aggregate pile, for producing the green body, so the target position of the production line robot is the position of the graded aggregate pile. The production task of the feeding robot is to convey other raw materials to the production line robot, so the target position of the feeding robot is the position where the production line robot receives the raw materials. The transfer robot needs to transfer the green body produced by the production line robot to the preset position, so the target positions of the transfer robot are the positions where the production line robot produces the green body and the preset position where the transferred green body is placed.

Optionally, the robot has at least one target position. In this case, when the robot reaches any target position according to the working path, an operation corresponding to the any target position is performed. Exemplarily, there are two target positions of the transfer robot, which are respectively the position where the production line robot produces the green body and the preset position where the transferred green body is placed. When the transfer robot reaches the position where the production line robot produces the green body, the transfer robot obtains the green body, and then transports the green body to the preset position according to the planned working path, and then unloads the green body.

Optionally, the production control method further includes determining a working mode of each of the robots according to the production task after determining the robots configured to perform the production task according to the production task. For example, the transfer robot can transfer the product to a first preset position or a second preset position. Transferring the product to the first preset position corresponds to a first working mode, and transferring the product to the second preset position corresponds to a second working mode. That is, if the production task is to transfer the product to the first preset position, the working mode of the transfer robot is determined to be the first working mode. By setting a variety of working modes, the robot can complete different production tasks.

At S2220, the working path of each of the robots is planned according to the initial position and the target position of each of the robots, and the corresponding robot is respectively controlled to work based on the working sequence, and the working path of each of the robots to complete the production task.

For example, in the production of products such as concrete, the robots include the production line robot and at least one feeding robot. Correspondingly, the planning the working path of each of the robots according to the initial position and the target position of each of the robots includes: planning the working path of the production line robot based on the initial position of the production line robot and a storage position of the production raw material; and planning the working path of the feeding robot based on the initial position and a material taking position of the feeding robot, and the target position in the planned working path of the production line robot. In the production of concrete products, the production line robot and at least one feeding robot are at least included. The initial positions of the production line robot and at least one feeding robot, as well as the material taking positions for the graded aggregate and each of the raw materials are obtained. The working path of the production line robot is planned according to the material taking position for the graded aggregate (that is, the target position of the production line robot) and the initial position of the production line robot, and the production line robot is controlled to move from the initial position to the target position to obtain the graded aggregate, for producing the concrete products. According to the target position of the production line robot (that is, the position where the production line robot obtains the graded aggregate), the initial position of at least one feeding robot, and the material taking position of each of the raw materials, the working path of at least one feeding robot is planned, so that the feeding robot can start from the initial position, move to the corresponding material taking position to obtain the raw material, and then convey the raw material to the production line robot.

Optionally, the production line robot includes at least one of a material taking device, a traveling device, a production device, and a vehicle frame. Optionally, the production line robot further includes at least one of a feeding device, a raw material metering device, a raw material conveying device, a stirring device, a green body forming device, a green body conveying device, and a green body palletizing device. Part or all of the above-mentioned devices can be mounted on a fixed platform, or on the vehicle frame. The vehicle frame and at least one of the above-mentioned devices can be driven to move together by the traveling device. The traveling device is mounted under the vehicle frame and includes independently rotating wheels. At least one wheel includes a braking device. In addition, the turning and in-situ reversing of the vehicle frame can be realized through differential control. A driving device of the traveling device is an engine and/or a motor, or the traveling device is directly pulled by a tractor. The material taking device is driven by a robotic arm and configured to pick up the graded aggregate and convey the graded aggregate into the feeding device. The feeding device is configured to receive the graded aggregate picked up by the material taking device and can selectively convey the graded aggregate through a belt to the raw material metering device for weighing. In addition, the raw materials transported by the feeding robot can also be weighed by the raw material metering device, so that each of the raw materials is proportioned according to a preset process formula. The raw material conveying device conveys the metered graded aggregate and other kinds of raw materials into the corresponding stirring device. The stirring device uniformly mixes and stirs different raw materials to meet the requirements of the subsequent forming steps. The green body forming device will make one or more mixed materials after stirring, into a finished green body, for example, through the principles of static pressure and vibration forming. The green body conveying device is a horizontal conveying mechanism, which is configured to convey each of the green bodies produced by the green body forming device to the subsequent green body palletizing device, while reserving a placement space for a green body to be formed next time. The green body palletizing device can be a frame-type lifting device, and be configured to move the green bodies conveyed in place by the green body conveying device to a palletizing position as a whole, and palletizes the green bodies into a target palletizing type layer by layer. In this embodiment, the green body forming device can be regarded as the production device, and at least one of the green body forming device, the feeding device, the raw material metering device, the raw material conveying device, the stirring device, the green body conveying device, and the green body palletizing device can also be regarded as the production device.

Optionally, the production line robot further includes a dust collection device and/or a dust reduction device. The dust collection device may be a negative pressure dust collection equipment, which utilizes negative pressure formed by a fan to absorb dust at a dust raising site with a certain degree of sealing in the equipment, into a dust collecting bag. For example, the dust in a sealed belt can be collected into the dust collecting bag by the negative pressure dust collection equipment. The dust reduction device is a fluid-atomizing dust reduction equipment, which includes atomizing nozzles arranged at some open dust raising sites and performing spraying along with actions, so as to eliminate the dust by atomizing to reduce the dust. Connecting positions between the belt and each of the devices cannot be sealed, and can become open dust raising sites, so the fluid-atomizing dust reduction equipment is arranged at these connecting positions to eliminate the dust.

Optionally, the production line robot can be independently equipped with a remote control, so that when an operator leaves a console, the operator can handle various emergency situations around the equipment and manually control key actions, which expands the range of operator's activities in space.

Optionally, the robots further include at least one of a transfer robot, a palletizing robot, a packaging robot, a finished product transfer robot, and a loading robot. Correspondingly, the planning the working path of each of the robots according to the initial position and the target position of each of the robots includes: based on an initial position, and a starting position and an ending position in the target position of at least one of the transfer robot, the palletizing robot, the packaging robot, the finished product transfer robot, and the loading robot, generating a working path of the at least one of the transfer robot, the palletizing robot, the packaging robot, the finished product transfer robot, and the loading robot. That is, according to the production task, the initial position, and the starting position and the end position in the target position of at least one of the transfer robot, the palletizing robot, the packaging robot, the finished product transfer robot, and the loading robot are obtained, and the working path of the corresponding robot is planned, in order to enable each of the robots to move according to the corresponding working path, so as to complete the production task.

Optionally, at least one of the robots includes at least one of a control module, a positioning module, a detection module, and a path correction module. The control module is configured to receive the working path of the robot, and control the robot to work according to the working path. The positioning module is configured to obtain the initial position of the robot and the real-time position during the working process of the robot. The detection module is configured to detect whether there is an obstacle in the working path during the working process of the robot. The path correction module is configured to control the robot to always move along the working path. In an embodiment, each robot includes the control module, the positioning module, the detection module, and the path correction module. In this embodiment, the initial position of each robot and the real-time position during the working process of each robot are obtained through the positioning module, and the position information is sent to a root server through a wireless communication module such as Win, so as to realize the sharing of the position and an operation area of each of the robots, so that the root server can plan the working path of each of the robots. The planned working path is received by the control module and the robot is controlled to move according to the working path. During the moving process, the detection module detects whether there is an obstacle in the working path. If there is an obstacle, the obstacle is bypassed. If there is no obstacle, the movement along the original working path is continued. Optionally, the detection module includes at least one of an infrared detector, an ultrasonic detector, and a laser detector. The path correction module is configured to control the robot to move along the working path to prevent the robot from deviating from the working path.

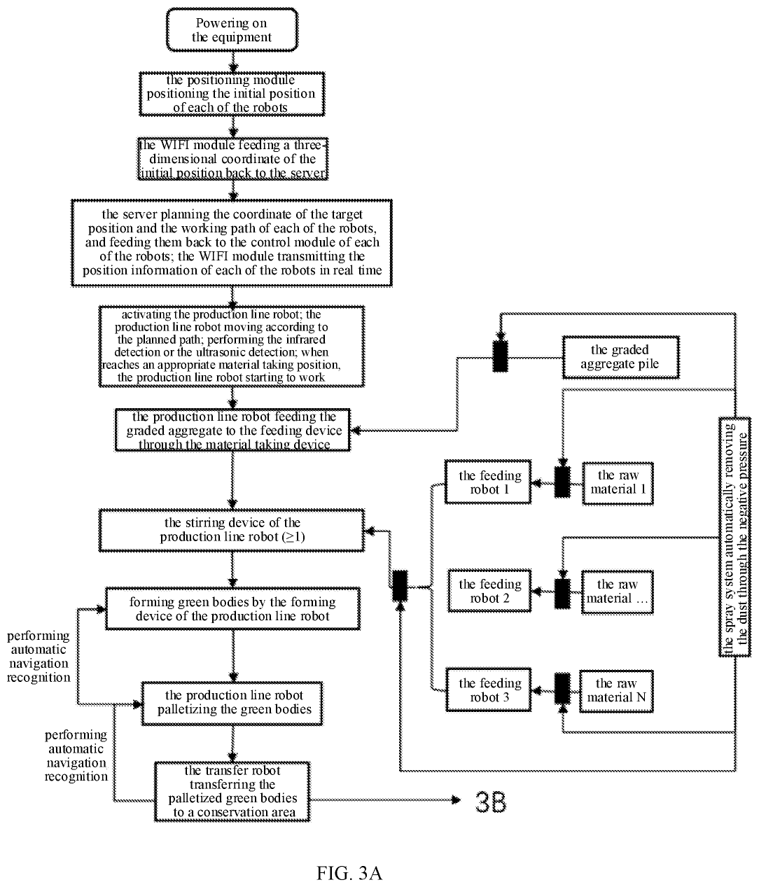

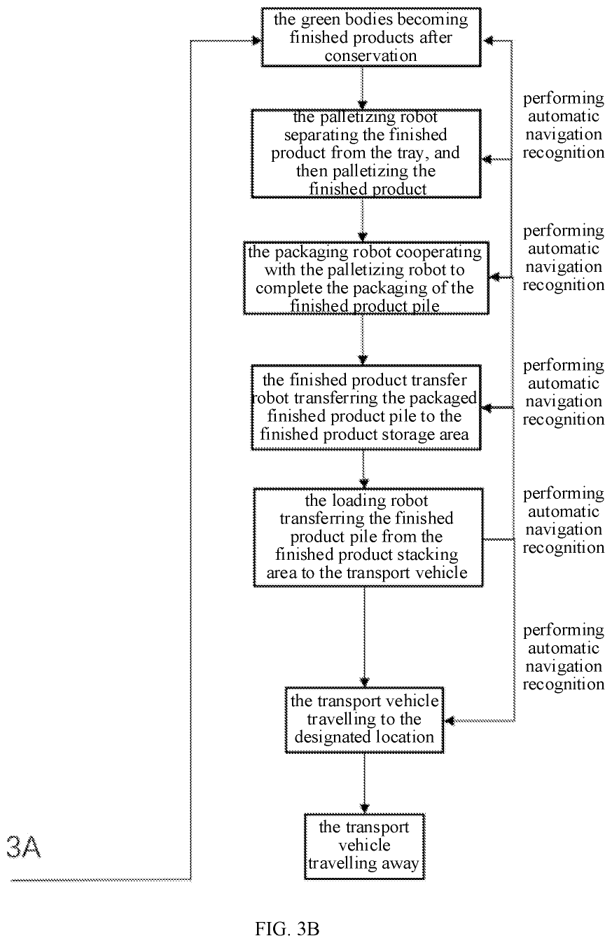

Optionally, on the basis of the above-mentioned embodiments, a production process of a concrete product according to an embodiment of the present disclosure will be described in detail with reference to FIGS. 3A and 3B. First, the equipment is powered on, the initial position of each of the robots is positioned through the positioning module, and then a three-dimensional coordinate of the initial position is fed back to the server through the wireless communication device such as a WIFI module. The server plans a coordinate of the target position (or, the position of the next working point) of each of the robots, and plans the working path of each of the robots according to the initial position and the target position. The planned working path is sent to the control module of each of the robots through the wireless communication device such as a WIFI module. In this embodiment, in order to prevent the robot from deviating from the working path, the wireless communication device such as a WIFI module can transmit the position information of each of the robots in real time. After the production line robot is activated, the control module of the production line robot controls the robot to move according to the working path, and the detection module detects whether there is an obstacle in the path, so that the production line robot can avoid the obstacle and reach the target position (that is, an appropriate material taking position for obtaining the graded aggregate) to start working After the production line robot reaches the target position, the graded aggregate is obtained through the material taking device and fed to the feeding device. The feeding robot obtains raw materials from various raw material positions to transport the raw materials to the production line robot. After the production robot obtains the raw materials, the production robot weighs the raw materials by the metering device, and proportions the raw materials according to a preset process formula, and stirs the metered raw materials by the stirring device. There is at least one stirring device, and the number of stirring devices is set according to the types of the raw materials. In an exemplary embodiment, the raw material 1 and the raw material 2 are stirred by one stirring device, and the raw material 3 and the raw material 4 are stirred by the other stirring device. The mixed raw materials after stirring are formed into a green body by the forming device according to the principles of static pressure and vibration forming. The formed green body is placed in a tray (also called a pallet). The formed green body and the tray are transferred to a conservation area by the transfer robot, and the green body becomes the finished product after conservation. The palletizing robot separates the green body or finished product from the tray, and then transports the green body or finished product to a palletizing area for palletizing. The packaging robot moves to the palletizing area to cooperate with the palletizing robot to package the palletized green bodies or finished products. The finished product transfer robot moves to the palletizing area to transfer the packaged finished products to a finished product storage area. When a transport vehicle enters a designated area, the vehicle is scanned, a position of a loading hopper of the vehicle is positioned according to vehicle information. The loading robot moves to a finished product stacking area to obtain the finished product and loads the finished product into the vehicle.

After the production tasks of the robots are completed, all devices are controlled to return to an initial running state and reset to a waiting area to wait for the arrival of the raw materials or prepare for leaving. Exemplarily, when the mixed raw materials are completely consumed and the transfer robot has transported all the green bodies produced by the production line robot out, the production line robot automatically returns all the devices to the initial running state and resets all the devices to the waiting area to wait for the arrival of the raw materials or prepare for leaving. Exemplarily, when the raw material corresponding to the feeding robot is consumed completely and the final loading and transportation of the raw material to the production line robot is completed, the feeding robot automatically returns to the initial running state and resets to the waiting area to wait for the arrival of the raw materials or prepare for leaving. After the transfer robot transfers the green body or finished product for the last time, the transfer robot returns to the initial running state and resets to the waiting area to wait for the arrival of the raw materials or prepare for leaving.

The production control method according to the above embodiments of the present disclosure can be applied to the production system including at least two robots with different production functions. The production control method includes the following steps: obtaining the production task; determining the robots configured to perform the production task according to the production task; obtaining the initial position of each of the determined robots, and determining the target position of each of the robots in the process of performing the production task according to the production task; planning the working path of each of the robots according to the initial position and the target position of each of the robots; respectively controlling the corresponding robot to work based on the working sequence and the working path of each of the robots to complete the production task. This production control method and the production system using this production control method solve the problem of low degree of automation of the production line, and achieve the effects of reducing labor costs and improving production efficiency.

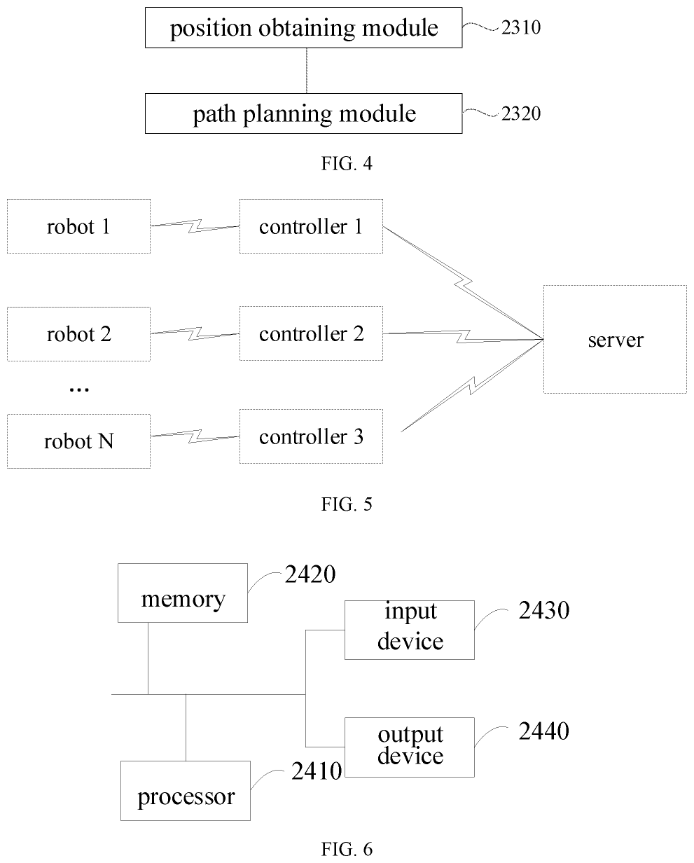

FIG. 4 is a diagram showing a structure of a production control device according to an embodiment of the present disclosure, which can be applied to the production system according to an embodiment of the present disclosure. The production system includes at least two robots with different production functions. The production control device includes a position obtaining module 2310 and a path planning module 2320.

The position obtaining module 2310 obtains an initial position, and a target position in a production process of each of the robots. The path planning module 2320 plans a working path of each of the robots according to the initial position and the target position of each of the robots, and respectively controls a corresponding robot to work based on a working sequence, and the working path of each of the robots to complete a production task.

Specifically, the path planning module 2320 may include: an initial working time determination unit, for determining initial working time of each of the robots based on the working sequence and a working duration of each of the robots; and a robot control unit, for respectively controlling the corresponding robot to work based on the initial working time and the corresponding working path.

In the above embodiment, the path planning module 2320 further includes a work completion information receiving unit. The path planning module 2320, in response to receiving work completion information of a robot in current procedure, sends a working path to a robot in next procedure to control the robot in the next procedure to start working; or respectively sends each of the working paths to the corresponding robot, and in response to receiving the work completion information of the robot in the current procedure, sends a work start instruction to the robot in the next procedure.

In the above-mentioned embodiment, the position obtaining module 2310 includes: a production task obtaining unit configured to obtain the production task and determine the robot configured to perform the production task according to the production task; a target position determination unit configured to obtain the initial position of each of the determined robots, and determine the target position of each of the robots in the process of performing the production task according to the production task.

In the above embodiment, the position obtaining module 2310 further includes a work mode determination unit configured to determine a work mode of each of the robots according to the production task.

Optionally, the robot has at least one target position. The robot is configured to perform an operation corresponding to the target position when any target position is reached according to the working path.

Optionally, the robots include a production line robot and at least one feeding robot.

Correspondingly, in the above-mentioned embodiments, the path planning module 2320 further includes a working path planning unit. The working path planning unit is configured to plan the working path of the production line robot based on the initial position of the production line robot and a storage position of the production raw material, and plan the working path of the feeding robot based on the initial position and the material taking position of the feeding robot, and the target position in the planned working path of the production line robot.

Optionally, the robot further includes at least one of a transfer robot, a palletizing robot, a packaging robot, a finished product transfer robot, and a loading robot.

Correspondingly, in the above-mentioned embodiments, the working path planning unit is further configured to generate the working path of the at least one of the transfer robot, the palletizing robot, the packaging robot, the finished product transfer robot, and the loading robot based on the initial position, and a starting position and an ending position in the target position of the at least one of the transfer robot, the palletizing robot, the packaging robot, the finished product transfer robot, and the loading robot.

Optionally, one or more robots include at least one of a control module, a positioning module, a detection module, and a path correction module. The control module is configured to receive the working path of the robot, and control the robot to work according to the working path. The positioning module is configured to obtain the initial position of the robot and the real-time position during the working process of the robot. The detection module is configured to detect whether there is an obstacle in the working path during the working process of the robot. The path correction module is configured to control the robot to always move along the working path.

Optionally, the production line robot includes at least one of a material taking device, a traveling device, a production device, and a vehicle frame.

Optionally, the production line robot further includes a dust collection device and/or a dust reduction device.

In the production system including at least two robots with different production functions to which the production control device according to this embodiment can be applied, the initial position and the target position in the production process of each of the robots are obtained, the working path of each of the robots is planned according to the initial position and the target position of each of the robots, and the corresponding robot is respectively controlled to work based on the working sequence and the working path of each of the robots to complete the production task, which solves the problem of low degree of automation of the production line, and achieve the effects of reducing labor costs and improving production efficiency.

The production control device according to the embodiments of the present disclosure can perform the production control method according to any embodiment of the present disclosure, and includes functional modules and beneficial effects corresponding to the performed method.

FIG. 5 is a schematic diagram showing a structure of a production equipment according to an embodiment of the present disclosure. As shown in FIG. 5, the production system includes a server, a controller, and at least two robots with different production functions.

In this embodiment, the server is configured to obtain an initial position, and a target position in a production process of each of robots, plan a working path of each of the robots according to the initial position and the target position of each of the robots, and send the working path of each of the robots to the controller. The controller receives the working path, and respectively controls the corresponding robot to work according to a working sequence and the working path. The robots are configured to perform production work to complete a production task.

The production equipment according to the embodiments of the present disclosure can be applied to a production system including at least two robots with different production functions, where the initial position and the target position in the production process of each of the robots are obtained, the working path of each of the robots is planned according to the initial position and the target position of each of the robots, and the corresponding robot is respectively controlled to work based on the working sequence and the working path of each of the robots to complete the production task, which solves the problem of low degree of automation of the production line, and achieve the effects of reducing labor costs and improving production efficiency.

FIG. 6 is a schematic diagram showing a structure of a production equipment according to an embodiment of the present disclosure, As shown in FIG. 6, the production equipment includes a processor 2410, a memory 2420, an input device 2430, and an output device 2440. Although only one processor is shown in FIG. 6, more processors 2410 in the production equipment may be provided. Although the processor 2410, the memory 2420, the input device 2430, and the output device 2440 in the production equipment are shown as being connected by a bus in FIG. 6, these components may also be connected by other means.

As a computer-readable storage medium, the memory 2420 can be configured to store software programs, computer-executable programs, and modules, for example, to store program instructions/modules corresponding to the production control methods in the embodiments of the present disclosure (for example, the position obtaining module 2310 and the path planning module 2320 in the production control device). The processor 2410 executes various functional applications and data processing of the production equipment by running the software programs, instructions, and modules stored in the memory 2420, to implement the above-mentioned production control method.

The memory 2420 may mainly include a program storage area and a data storage area. The program storage area may store an application program required for at least one function, and an operating system. The data storage area may store data created according to use of a terminal, and the like. In addition, the memory 2420 may include a high-speed random-access memory, and may further include a non-transitory memory, such as at least one magnetic disk storage device, flash memory device, or other non-transitory solid-state storage device. In some examples, the memory 2420 may further include memories provided remotely from the processor 2410. These remote memories may be connected to the production equipment through a network. Examples of such network include, but are not limited to, an Internet, an intranet, a local area network, a mobile communication network, and combinations thereof.

The input device 2430 can be configured to receive input numerical or character information, and generate signal input related to user settings and function controls of the production equipment. The output device 2440 may include a display device such as a display screen.

In the above description, it has been mentioned that the production line robot for producing the concrete products according to the embodiments of the present disclosure can be mounted on a fixed platform, or can be mounted on a platform with movable capability, such as a vehicle frame or a vehicle body. The vehicle body can be a tractor, trailer, semi-trailer, or flatbed.

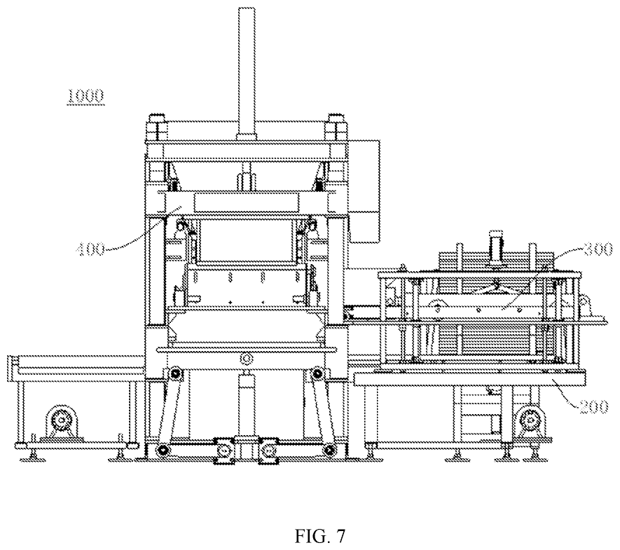

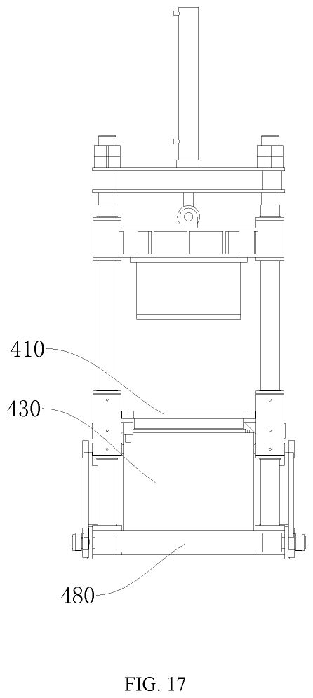

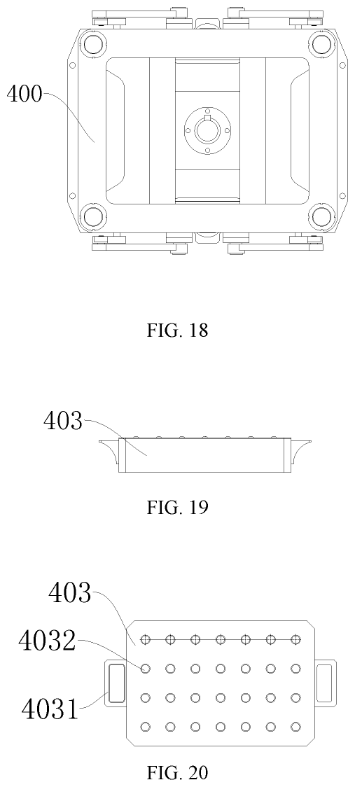

A brick making system configured to be mounted to the fixed platform and a vehicle-mounted brick making system will be described in detail below with reference to FIGS. 7-20 and FIGS. 21-24, respectively.

FIGS. 7 to 20 illustrate the brick making system configured to be mounted to the fixed platform according to an embodiment of the present disclosure.

A brick making system 1000 according to an embodiment of the present disclosure will be described below with reference to the accompanying drawings. The brick making system 1000 has a compact structure, small occupied space, and construction convenience.

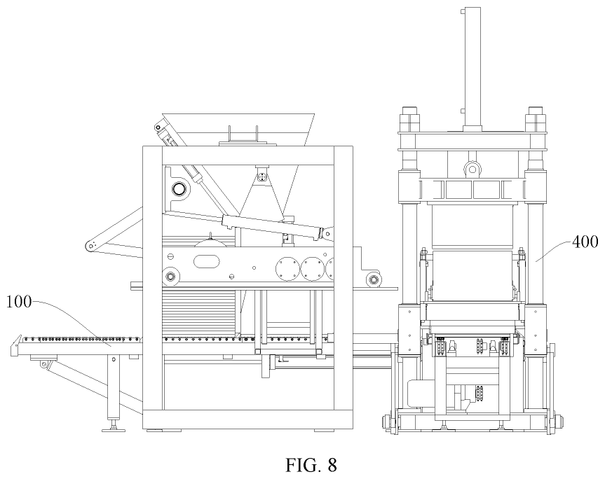

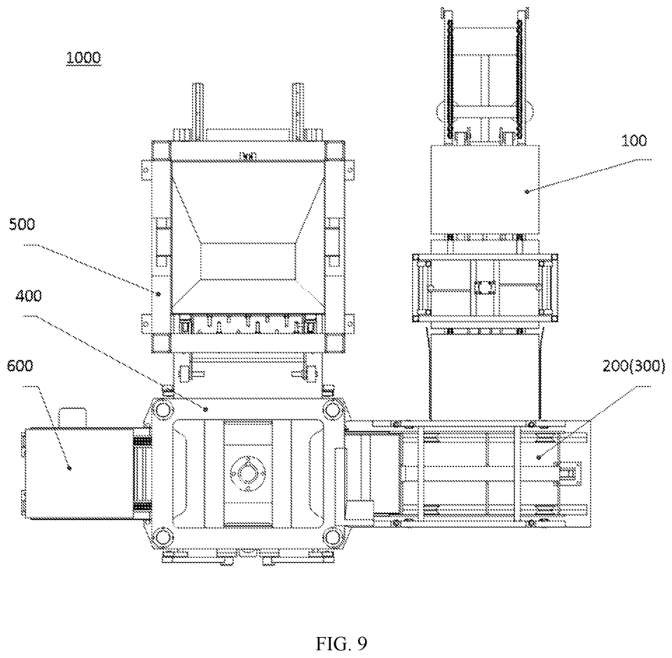

FIG. 7 is a front view of the brick making system according to the embodiment of the present disclosure; FIG. 8 is a side view of the brick making system in FIG. 7 according to the embodiment of the present disclosure; FIG. 9 is a top view of the brick making system in FIG. 7 according to the embodiment of the present disclosure.

Referring to FIGS. 7 to 9, the brick making system 1000 according to the embodiment of the present disclosure at least includes a surface material distribution device 300, a brick making machine 400, and a bottom material distribution device 500. The bottom material distribution device 500 is connected to one side of the brick making machine 400 to feed bottom material to the brick making machine 400 in a first direction. The surface material distribution device 300 is connected to the other side of the brick making machine 400 adjacent to the one side to feed surface material to the brick making machine 400 in a second direction. The surface material distribution device 300 and the bottom material distribution device 400 are arranged on the sides of the brick making machine 400 in different directions, which helps to reduce the length of the brick making system 1000. In an embodiment, the first direction is perpendicular to the second direction, so that the surface material distribution device 300 and the bottom material distribution device 400 do not interfere with each other and can enable the layout of each of the components of the brick making system 1000 to be compact.

In addition, in order to achieve a higher degree of integration of the production system, the brick making system 1000 according to the embodiment of the present disclosure may further include at least one of a first feeding device 100, a second feeding device 200, and a brick discharging platform 600.

Specifically, in some embodiments of the present disclosure, the first feeding device 100 may be a first conveying device for conveying pallets, such as a longitudinal pallet feeding vehicle or the like. When the brick making system 1000 works, a mold mechanism of the brick making machine 400 piles up and stacks the formed bricks on a brick pallet in turn. When the number of stacked layers reaches a set value, the bricks in the current batch can be transported away through a conveying mechanism. Then, the brick making system is provided with another new brick pallet. In order to increase the working efficiency of the brick making system 1000, empty brick pallets are usually stacked and placed for later use. When the brick making system is working, the brick pallet located at the very bottom is taken out first when the brick pallet is taken for use. In some embodiments, the bricks in the current batch are conveyed to the brick discharging platform 600 by a conveying mechanism of the second feeding device 200 to be described below, and then transported away by a conveying mechanism provided on the brick discharging platform 600. In other embodiments, if the conveying mechanism of the brick discharging platform 600 extends into the brick making machine 400, the bricks in the current batch together with the pallets are directly transported away by the conveying mechanism of the brick discharging platform 600. In other some embodiments, a separate conveying mechanism may be provided in the brick making machine 400, to convey the pallets and the finished bricks to the brick discharging platform 600, an external transport mechanism or an external platform. In the above embodiments, the brick discharging platform 600 is connected to the brick making machine 400 and arranged to be opposite to the surface material distribution device 300, and conveys the materials in the same direction as the surface material distribution device 300. In other embodiments, the brick discharging platform 600 may be connected to the brick making machine 400 and arranged to be opposite to the bottom material distribution device 500.

The second feeding device 200 is located downstream of the first feeding device 100, and a feeding direction of the second feeding device 200 forms a predetermined angle with a feeding direction of the first feeding device 100. The second feeding device 200 is provided with a conveying mechanism, and this first conveying mechanism may be, for example, a sprocket and chain structure. For example, the second feeding device 200 may be a second conveying device for conveying pallets, such as a transverse pallet feeding vehicle or the like. The feeding direction of the second feeding device 200 forms an included angle having a predetermined angle with the feeding direction of the first feeding device 100, which is further advantageous to reduce the occupied space of the brick making system 1000 and facilitate construction. In an embodiment, the predetermined angle is between 60 degrees and 120 degrees. In a further embodiment, the predetermined angle is about 90 degrees, that is, the feeding direction of the second feeding device 200 is perpendicular to the feeding direction of the first feeding device 100.

In an embodiment, the surface material distribution device 300 is disposed on the second feeding device 200, and the surface material distribution device 300 is formed integrally with the second. feeding device 200. For example, in some embodiments of the present disclosure, the surface material distribution device 300 may be disposed on the top of the second feeding device 200, and the surface material distribution device 300 may be formed integrally with the second feeding device 200. In some embodiments of the present disclosure, the surface material distribution device 300 may be a surface material distribution vehicle. The transverse pallet feeding vehicle is formed integrally with the surface material distribution vehicle, such that the surface material distribution and the transverse pallet feeding mechanism are integrated into one, so that the material distribution and the pallet feeding can be realized simultaneously, and the entire brick making system requires lesser space compared with the prior art. In addition, according to the brick making system 1000 according to the embodiment of the present disclosure, the surface material distribution device 300 is formed integrally with the second feeding device 200, such that the brick making system 1000 can also be modularized, which is convenient to change sites and has good flexibility. In the above embodiments, the surface material distribution device 300 is formed integrally with the second feeding device 200, however, the present disclosure is not limited to this. As required, for example, the bottom material distribution device 500 can also be designed to be formed integrally with the second feeding device 200. In a feeding direction of the brick making system 1000, the brick making machine 400 is disposed downstream of the second feeding device 200, and the brick making machine 400 includes a mold frame 410, a pressing head 420 disposed above the mold frame 410, and a vibrating stand 430 disposed below the mold frame 410.

In an embodiment, the bottom material distribution device 500 includes a double oil cylinder connecting rod structure, so that the bottom material distribution device 500 distributes the material into the brick making machine 400 reciprocally.

The brick discharging platform 600 is connected to the brick making machine 400, and a second conveying mechanism is provided on the brick discharging platform 600. The finished bricks are suitable for being conveyed by the second conveying mechanism. In some implementations, the second. conveying mechanism may be, for example, a sprocket and chain structure or the like driven by a drive motor. However, the present disclosure is not limited thereto. For example, the second conveying mechanism may be at least one of a sprocket and chain, a pulley and belt, a crank link mechanism, and a manipulator.

The first feeding device 100 of the brick making system 1000 according to the embodiment of the present disclosure may further include an air cylinder, a hook, an equidistant intermittent pallet feeding mechanism, an oil cylinder guide wheel structure, etc. Here, the air cylinder, hook, and equidistant intermittent pallet feeding mechanism and the oil cylinder guide wheel structure can adopt conventional structures, which will not be described repeatedly herein.

In an embodiment of the present disclosure, the specific operation processes of the brick making system 1000 according to the embodiment of the present disclosure are as follows. A forklift places a stack of pallets 111 at an end position of the first feeding device 100 (for example, a longitudinal pallet feeding vehicle), and then pushes the pallets forward by a distance of one pallet 111, and thus the stack of pallets is in place. The bottommost pallet 111 is conveyed to the second feeding device 200 and the surface material distribution device 300 (also known as transverse pallet feeding vehicle/surface material distribution vehicle) by the equidistant intermittent pallet feeding mechanism using the air cylinder and the hook. The pallet 111 is conveyed to the vibrating stand 430 of the brick making machine 400 by the motor, the sprocket and chain structure of the transverse pallet feeding vehicle/surface material distribution vehicle, and thus the pallet 111 is in place. At the same time, the bottom material distribution device 500 (for example, the bottom material distribution vehicle) starts to distribute the bottom material back and forth into the brick making machine 400 through the double oil cylinder connecting rod structure. In this case, the vibrating stand 430 in the brick making machine 400 is always working, the pressing head 420 in the brick making machine 400 is pressed down for the first time, the bottom material is formed, and the pressing head 420 is raised back. Then, the transverse pallet feeding vehicle/surface material distribution vehicle pushes the formed bottom material to the brick making machine 400 through the oil cylinder guide wheel structure, and the surface material distribution is started. After the surface material distribution is completed, the pressing head 410 in the brick making machine 400 completes a second pressing down, so that the surface material is formed, that is, the brick making is completed. In this case, the motor, the sprocket and chain structure in the transverse pallet feeding vehicle/surface material distribution vehicle work again, the pallet 111 in the brick making machine 400 is pushed to the brick discharging platform 600. The motor and the sprocket and chain structure on the brick discharging platform 600 are used to convey the pallet 111 to a grabbing position, and thus the whole process of brick making ends.

According to the brick making system 1000 according to the embodiment of the present disclosure, the feeding direction of the second feeding device 200 is arranged to form the included angle having the predetermined angle with the feeding direction of the first feeding device 100, it is convenient for construction and is advantageous to reduce the occupied space of the brick making system 1000. The surface material distribution device 300 is formed integrally with the second feeding device 200, such that the surface material distribution and the pallet feeding mechanism are integrated into one, so that the material distribution and the pallet feeding can be realized simultaneously, the structure is compact, and the entire brick making system requires lesser space compared with the prior art.

According to some embodiments of the present disclosure, the first feeding device 100 is provided with a pallet pushing mechanism configured to push the pallet 111.

In some embodiments of the present disclosure, the forklift is used to place a stack of pallets 111 at the end position of the first feeding device 100 (for example, the longitudinal pallet feeding vehicle), and the stack of pallets 111 can be pushed forward by a distance of one pallet 111 through the pallet pushing mechanism.

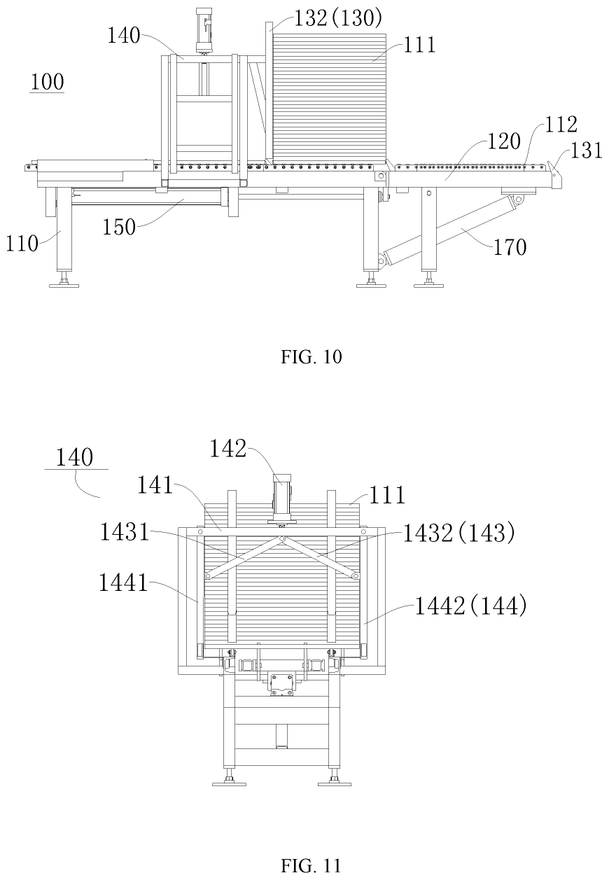

The first feeding device (specifically, the longitudinal pallet feeding vehicle) 100 according to the embodiment of the present disclosure will be described in detail below with reference to FIGS. 10 to 12.

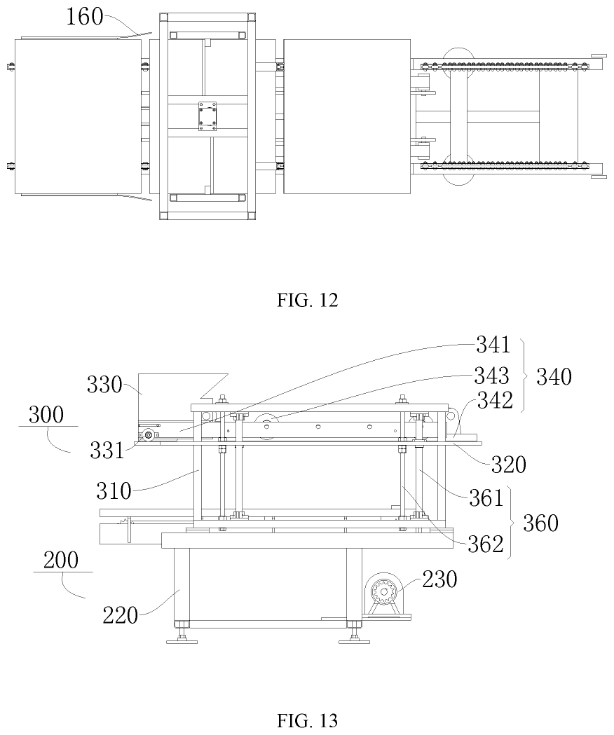

FIG. 10 is a front view of the first feeding device (longitudinal pallet feeding vehicle) in the brick making system shown in FIG. 7 according to the embodiment of the present disclosure; FIG. 11 is a side view of the first feeding device (longitudinal pallet feeding vehicle) in the brick making system shown in FIG. 10 according to the embodiment of the present disclosure; and FIG. 12 is a top view of the first feeding device (longitudinal pallet feeding vehicle) in the brick making system shown in FIG. 10 according to the embodiment of the present disclosure.

Referring to FIGS. 10 to 12, according to some embodiments of the present disclosure, the first feeding device 100 includes a first supporting frame 110, a foldable feeding holder 120, a limiting structure 130, a pallet aligning structure 140, a pallet conveying cylinder 150, and a guide structure 160.

Specifically, referring to FIG. 10, a plurality of pallets 111 are stacked on the first supporting frame 110. The foldable feeding holder 120 is hinged with the first supporting frame 110. The limiting structure 130 is configured to limit the pallets 111. The limiting structure 130 includes a first limiting structure 131 and a second limiting structure 132. The first limiting structure 131 is disposed on the foldable feeding holder 120. In some embodiments of the present disclosure, the first limiting structure 131 may be, for example, a pallet feeding check claw, etc. The second limiting structure 132 is disposed on the first supporting frame 110, and the second limiting structure 132 may be a pallet limiting bracket, etc.

The pallet aligning structure 140 is configured to organize and align the pallets 111. In some embodiments of the present disclosure, the pallet aligning structure 140 of the longitudinal pallet feeding vehicle may be driven by a motor or a hydraulic cylinder.

The first supporting frame 110 may be provided with an aluminum alloy slide rail 112. The conveying of the pallets 111 is facilitated by the aluminum alloy slide rail 112. The aluminum alloy slide rail can also be called a slide rail.

In some embodiments of the present disclosure, the pallet conveying cylinder 150 is disposed at the bottom of the first supporting frame 110, configured to push the bottommost pallet 111 out to the pallet aligning structure 140. Therefore, the bottommost pallet 111 can be pushed out to the pallet aligning structure 140 by the pallet conveying cylinder 150, and the position of the pallet 111 can be organized by the pallet aligning structure 140.

The guide structure 160 is disposed on the first supporting frame 110, so as to guide the aligned pallets 111. The pallet conveying cylinder 150 conveys the aligned pallets to the second feeding device 200. For example, referring to FIG. 12, in some embodiments of the present disclosure, the guide structure 160 may include a guide plate. The guide plate may include a pair of guide plates. A distance between the pair of guide plates gradually decreases in the direction of conveying the pallet, until the distance remains constant. The guide structure 160 can be used to guide the aligned pallets 111, and the pallet conveying cylinder 150 can convey the aligned pallets to the second feeding device 200.

Further, referring to FIG. 11, the pallet aligning structure 140 includes a frame body 141, a pallet aligning cylinder 142, an alignment connecting rod 143, and a pallet clamping rod 144.

Specifically, the pallet aligning structure 140 is driven by the pallet aligning cylinder 142 to organize and align the pallets 111.

The alignment connecting rod 143 is hinged with the pallet aligning cylinder 141. The alignment connecting rod 143 may include a first alignment connecting rod 1431 and a second alignment connecting rod 1432. The first alignment connecting rod 1431 and the second alignment connecting rod 1432 are respectively hinged with the pallet aligning cylinders 142. Specifically, one end of the first alignment connecting rod 1431 is connected to one end of the second alignment connecting rod 1432, and the one end of the first alignment connecting rod 1431 and the one end of the second alignment connecting rod 1432 are both hinged with the pallet aligning cylinder 142.

The pallet clamping rod 144 is hinged with the frame body 141, and the pallet clamping rod 144 includes a first pallet clamping rod 1441 and a second pallet clamping rod 1442. The first pallet clamping rod 1441 is hinged with the frame body 141, and the second pallet clamping rod 1442 is hinged with the frame body 141. Specifically, the other end of the first alignment connecting rod 1431 is hinged with the first pallet clamping rod 1441, and the other end of the second alignment connecting rod 1432 is hinged with the second pallet clamping rod 1442.

For example, in some further embodiments of the present disclosure, the other end of the first alignment connecting rod 1431 can be hinged with a middle position or an upper position of the first pallet clamping rod 1441, and the other end of the second alignment connecting rod 1432 can be hinged with a middle position or an upper position of the second pallet clamping rod 1442, but the present disclosure is not limited thereto.

According to the brick making system 1000 of the embodiment of the present disclosure, the pallet 111 is pushed to the foldable feeding holder 120 by the forklift. In this process, the pallet 111 is prevented from going back by the first limiting structure 131 (e.g., the pallet feeding check claw), and then the pallet 111 is pushed to the second limiting structure 132 (e.g., the pallet limiting bracket) by the air cylinder or manually, and thus the pallet 111 is in place. Then, the bottommost pallet 111 of the pallets 111 can be pushed out to be below the pallet aligning structure 140 by the pallet conveying cylinder 150, and the pallet aligning structure 140 can be driven by the pallet aligning cylinder 142 to organize and align the pallets 111. Then, the pallet conveying cylinder 150 is used to push the pallets 111 into the transverse pallet feeding vehicle, and thus the operation of the longitudinal pallet feeding vehicle is completed. During the process of being pushed to the transverse pallet feeding vehicle, the pallets 111 are guided by the guide structure 160 such as guide plate.

The principle of aligning the pallets lies in that the pallet aligning cylinder 142 is stretched and retracted, such that the alignment connecting rod 113 connects the pallet aligning cylinder 142 and the pallet clamping rods 144 through a rotating hinge point, so that the pallet clamping rods 144 on both sides rotate around the rotating hinge point, so as to achieve the synchronous motion of the pallet clamping rods 144, and complete the alignment of the pallets.

According to the brick making system 1000 of the embodiment of the present disclosure, the air cylinder and the connecting rod are used to align the pallets on the pallet feeder, so that not only the pallet aligning structure has a simple structure, but also the space occupied by the pallet aligning structure can be reduced.

According to some embodiments of the present disclosure, as shown in FIG. 10, a supporting member 170 is further provided between the foldable feeding holder 120 and the first supporting frame 110. The foldable inclined supporting member 170 is hinged with the foldable feeding holder 120 and the first supporting frame 110, respectively, and inclinedly disposed between the foldable feeding holder 120 and the first supporting frame 110. On the one hand, the arrangement of the supporting member 170 is beneficial to improve the structural strength of the first feeding device 100. On the other hand, during transportation, if there is insufficient space, rotary pins at the hinge point for supporting the rotation at both ends of the supporting member 170 can be removed, the inclined supporting member 170 can be detached, and the foldable feeding holder 120 can be further folded upward by 90° to achieve the purpose of shortening the size of the first feeding device 100 (for example, the longitudinal pallet feeding vehicle).

According to some embodiments of the present disclosure, the pallet pushing mechanism may be a hydraulic cylinder, an air cylinder, or a single-axis manipulator. Of course, in some embodiments of the present disclosure, the operation of pushing the pallet 111 may also be performed manually.

In some specific embodiments of the present disclosure, for operations of feeding the materials to the brick making machine 400 in three directions, the feeding direction of the second feeding device 200 and the feeding direction of the first feeding device 100 are arranged at an included angle of 90 degrees, so that the whole machine adopts a right-angle layout structure, which greatly reduces the space requirement, and the three sides of the brick making machine 400 can receive the fed materials or output the green bodies of the bricks, thereby reducing the occupied space of the brick making system 1000 and improving the system efficiency.

In some embodiments of the present disclosure, the second feeding device 200 and the first feeding device 100 may be in a T-shaped layout, an L-shaped layout, or the like.

According to the brick making system 1000 of the embodiment of the present disclosure, by arranging the second feeding device 200 and the first feeding device 100 in right-angle layout, the problem of excessively long period caused by single-sided material distribution, pallet feeding, and pallet discharging can be solved, and the production cycle can be shortened; the problems of excessive land occupation and construction inconvenience caused by the successive connection of various devices in the existing brick making system along one direction can be solved. Thus, the brick making system 1000 according to the embodiment of the present disclosure can not only save construction costs, but also be time-saving and labor-saving, and can further realize double-sided material distribution, and feeding/discharging the pallets on both sides, which simplifies the control of the equipment and/or mechanisms of the system.

Of course, in some embodiments of the present disclosure, the second feeding device 200 and the first feeding device 100 may also be arranged at an included angle of other angles between 60 degrees and 120 degrees (for example, 60 degrees, 70 degrees, 80 degrees, 100 degrees, 110 degrees or 120 degrees, etc.).

The integrated second feeding device/surface material distribution device in the brick making system according to the embodiment of the present disclosure will be described in detail below with reference to FIGS. 13 to 15.

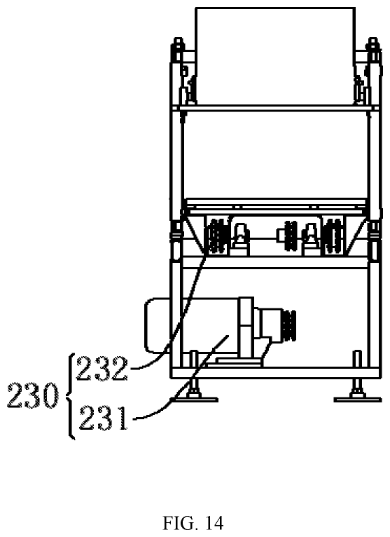

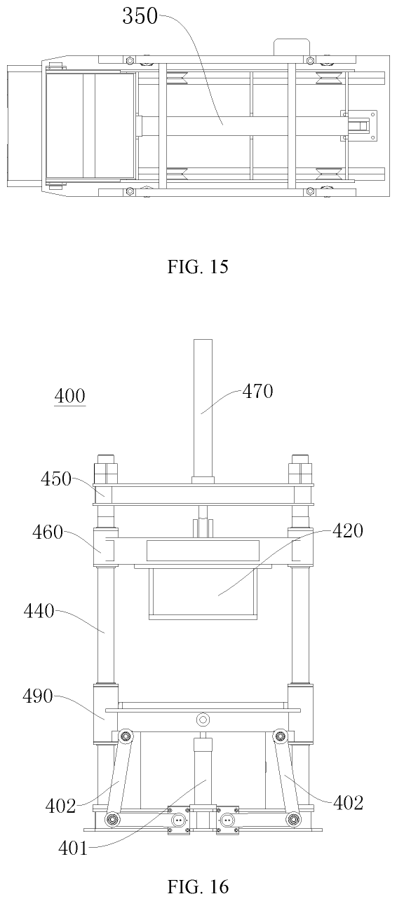

FIG. 13 is a front view of a second feeding device/surface material distribution device (specifically, transverse pallet feeding vehicle/material distribution vehicle) in the brick making system shown in FIG. 7 according to an embodiment of the present disclosure; FIG. 14 is a side view of the second feeding device/surface material distribution device (the transverse pallet feeding vehicle/surface material distribution vehicle) in the brick making system shown in FIG. 13 according to the embodiment of the present disclosure; FIG. 15 is a top view of the second feeding device/surface material distribution device (the transverse pallet feeding vehicle/surface material distribution vehicle) in the brick making system shown in FIG. 14 according to the embodiment of the present disclosure.

Referring to FIGS. 13 to 15, according to some embodiments of the present disclosure, the second feeding device 200 includes a second supporting frame 220, a driving mechanism 230, and a first conveying mechanism.

Specifically, as shown in FIGS. 13 and 14, the driving mechanism 230 drives the first conveying mechanism to convey the pallet 111 to the vibrating stand 430. The driving mechanism 230 includes a driving motor 231. In some embodiments, the first conveying mechanism is a sprocket and chain 232 in driving connection with the drive motor 231. However, the present disclosure is not limited thereto, and the first conveying mechanism may be at least one of a sprocket and chain, a pulley and belt, a crank link mechanism, and a manipulator.

The pallet feeding process of the brick making system 1000 according to the embodiment of the present disclosure includes: after the longitudinal pallet feeding vehicle feeds the pallets 111, the sprocket and the chain 232 is driven by the driving motor 231 to intermittently feed the pallets onto the vibrating stand 430 of the brick making machine 400, and thus the pallet feeding process ends.

Further, referring to FIGS. 13 and 15, the surface material distribution device 300 includes a third supporting frame 310, a surface material distribution vehicle 320, a surface material hopper 330, a hopper guide member 310, and a hopper driving hydraulic cylinder 350 (referring to FIG. 15).

Specifically, the third supporting frame 310 is disposed above the second supporting frame 220 of the second feeding device 200. The surface material distribution vehicle 320 is disposed on the third supporting frame 310, and has an adjustable height.

The surface material hopper 330 includes a supporting wheel 331. The supporting wheel 331 can be a front supporting wheel of the hopper. The hopper guide member 340 is configured to guide the surface material hopper. The hopper guide member 340 may include a hopper push rod 341, a hopper travelling guide bar 342, and a hopper travelling guide wheel 343. The hopper driving hydraulic cylinder 350 is connected to the surface material hopper 330 to drive the surface material hopper 330 to reciprocate.

The surface material distribution process of the brick making system 1000 according to the embodiment of the present disclosure includes: pushing and pulling the surface material hopper 330 by the hopper driving hydraulic cylinder 350, while supporting the surface material hopper 330 by the front supporting wheel of the hopper and guiding the movement of the surface material hopper 330 by the hopper guide member 340, to complete the surface material distribution.

Further, referring to FIG. 13, the surface material distribution device 300 further includes a height adjusting mechanism 360 configured to adjust a height of the surface material distribution vehicle 320. The height adjusting mechanism 360 includes a vertical guide shaft 361 for surface material vehicle and a supporting screw 362 for surface material vehicle.

Specifically, the vertical guide shaft 361 for surface material vehicle is configured to adjust the height of the surface material distribution vehicle. An upper end of the supporting screw 362 for surface material vehicle is connected to the surface material distribution vehicle 320, and a lower end of the supporting screw 362 for surface material vehicle is connected to the second supporting frame 220. The supporting screw 362 for surface material vehicle is locked by a nut.

The surface material distribution device 300 may include a linear bearing. After the replacement of the mold is performed, the height adjusting process of the surface material distribution vehicle 320 may include: loosening the fastening nut on the supporting screw 362 for surface material vehicle, and vertically moving the surface material distribution vehicle 320 to a desired height by the guidance of the linear bearing and the vertical guide shaft 361 for surface material vehicle, and then locking the nut and thus completing the height adjustment of the surface material distribution vehicle 320.

According to the brick making system 1000 of the embodiment of the present disclosure, the surface material vehicle and the pallet feeding vehicle are combined into one, which greatly saves mounting space and time, and the height of the surface material vehicle can be adjusted by the linear bearing and the screw (for example, the supporting screw 362 for surface material vehicle), which is simple and convenient.

In some embodiments of the present disclosure, the brick making machine 100 may have a frame-type structure.

Referring to FIGS. 16 to 18, according to some embodiments of the present disclosure, in addition to the pressing head 420, the vibrating stand 430, and the mold frame 410, the brick making machine 400 may further include a machine supporting guide shaft 440, a machine supporting upper plate 450, a pressing head guiding fixing seat 460, a pressing head lifting hydraulic cylinder 470, a machine supporting lower plate 480, a frame guiding fixing seat 490, a frame lifting hydraulic cylinder 101, and a connecting rod 402.

Specifically, the machine supporting upper plate 450 is disposed on the top of the machine supporting guide shaft 440. The pressing head guiding fixing seat 460 is connected to the machine supporting guide shaft 440. The pressing head guiding fixing seat 460 can be located below the machine supporting upper plate 450. The pressing head 420 is detachably disposed on the pressing head guiding fixing seat 460. For example, the pressing head 420 may be disposed on the pressing head guiding fixing seat 460 by means of screw connection. The pressing head lifting hydraulic cylinder 470 is configured to drive the pressing head 420 to raise and lower.

The machine supporting lower plate 480 is disposed at the bottom of the machine supporting guide shaft 440. The vibrating stand 430 is disposed on the machine supporting lower plate 480. The frame guiding fixing seat 490 is connected to the machine supporting guide shaft 440, and the frame guiding fixing seat 490 can be located above the machine supporting lower plate 480. The mold frame 410 is detachably connected to the frame guiding fixing seat 490, for example, the mold frame 410 can be connected to the frame guiding fixing seat 490 by means of screw connection. The frame lifting hydraulic cylinder 401 is configured to drive the mold frame 410 to raise and lower. The connecting rod 402 is disposed between the machine supporting lower plate 480 and the frame guiding fixing seat 490. In some embodiments, two connecting rods 402 may be included.

According to the brick making system 1000 of the embodiment of the present disclosure, the brick making machine 400 adopts a structure with four beams and four posts, and the double hydraulic drive is used to drive the connecting rods to raise the mold frame. The hydraulic cylinders are required to be synchronized to ensure that the vibrating stand 430 remains level.

Further, referring to FIGS. 19 and 20, the brick making machine 400 further includes a special tool 403 for mold replacement. The special tooling 403 for mold replacement includes a handle 4031. The special tooling 403 for mold replacement is suitable to be placed on the vibrating stand 430. A plurality of universal balls 4032 are provided in the special tooling 403 for mold replacement, so as to be suitable for containing the pressing head 420 and the mold frame 410. For example, in some embodiments of the present disclosure, an outer contour of the special tooling 403 for mold replacement may be substantially rectangular.

The mold replacement process of the brick making system 1000 according to the embodiment of the present disclosure includes as follows. The pressing head guiding fixing seat 460 is pushed downward by the pressing head lifting hydraulic cylinder 470, so that the pressing head 420 is placed on the mold frame 410. The connecting screw of the pressing head guiding fixing seat 460 and the pressing head 420 is loosened, so that the pressing head lifting hydraulic cylinder 470 moves upward. Then, the frame guiding fixing seat 490 is pushed upward by an appropriate distance through the frame lifting hydraulic cylinder 401, so that there is a certain safety distance (which can be adapted according to actual needs) between the mold frame 410 and the vibrating stand 430. And then, the special tooling 403 for mold replacement is placed on the vibrating stand 430, and then the screw between the mold frame 410 and the frame guiding fixing seat 490 is loosened. Thus, the mold (namely, the mold frame 410 and the pressing head 420) is entirely removed and placed on the special tooling 403 for mold replacement. The special tooling 403 for mold replacement is manually turned by 90°, so that short sides thereof face outward, and then the tooling is pulled out, thus the disassembly of the molds is completed. The process of mounting the mold is the reverse of the process described above.

Other components and operations of the brick making system 1000 according to the embodiment of the present disclosure are known to those of ordinary skill in the art, and will not be described in detail herein.

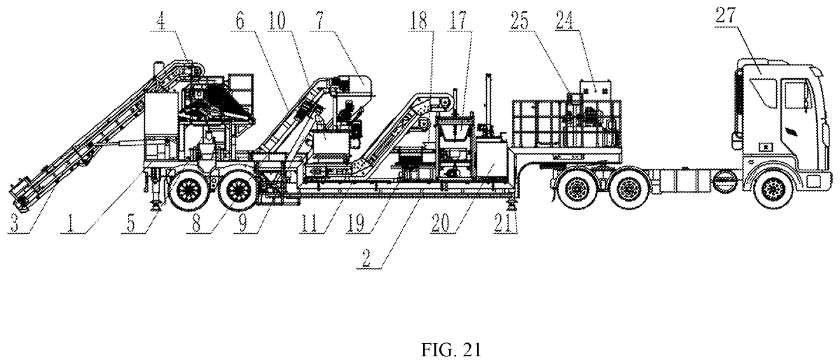

A vehicle-mounted brick making system will be described below with reference to FIGS. 21 to 24.

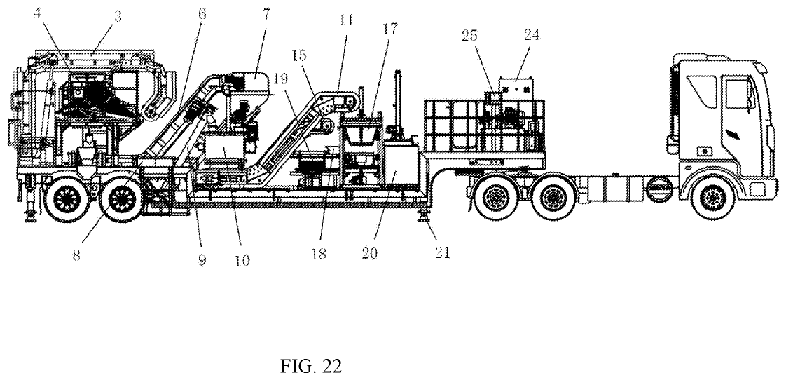

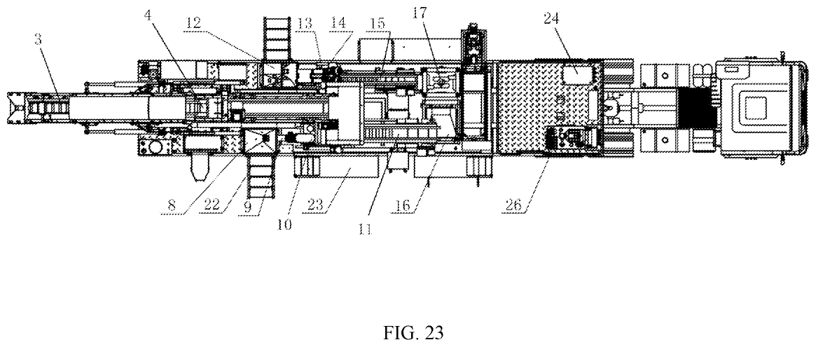

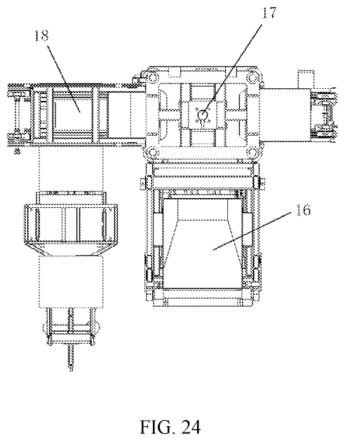

Specifically, FIGS. 21 to 24 show a brick making system in a form of an integrated machine for crushing and brick making according to the present embodiment. FIG. 21 is a front view of the integrated machine for crushing and brick making according to an embodiment of the present disclosure. FIG. 22 is another front view of the integrated machine for crushing and brick making according to an embodiment of the present disclosure, showing a state in which a feeding belt shown in FIG. 21 is folded upward. FIG. 23 is a top view of the integrated machine for crushing and brick making shown in FIG. 21 according to an embodiment of the present disclosure. FIG. 24 is a top view of an area of a brick making machine shown in FIG. 21.

As shown in FIG. 21, the integrated machine for crushing and brick making according to this embodiment includes a movable vehicle body 1, and a concave area 2 is arranged in the middle of the vehicle body 1. A bottom material stirring equipment 10, a surface material stirring equipment 14, and a brick making machine 17 are disposed in the concave area 2, which reduces heights of the bottom material stirring equipment 10, the surface material stirring equipment 14, and the brick making machine 17, and reduces the vibration of the overall brick making system, and facilitate workers to operate the brick making system. In addition, the bottom material stirring equipment 10 is disposed in the concave area 2 of the vehicle body 1, which not only reduces the height of the bottom material stirring equipment 10, but also reduces a length of an aggregate belt conveyor 6 when the upwardly inclined aggregate belt conveyor 6 is used to convey the material toward the bottom material stirring equipment 10, thereby further reducing the length of the vehicle body 1 as a whole.

A rear end area of the vehicle body 1 is provided with a crushing equipment 4. The crushing equipment 4 can crush the construction waste into aggregate. A feeding belt conveyor 3 is further connected to a rear end of the vehicle body 1. The feeding belt conveyor 3 is configured to convey the construction waste into the crushing equipment 4. When the feeding belt conveyor 3 is in an unfolded state, the feeding belt conveyor 3 extends toward the rear of the vehicle body 1. Considering the angle of repose of the material, the feeding belt conveyor 3 is set to be inclined upward at a certain angle to prevent the material from sliding downward when being conveyed on the feeding belt conveyor 3. In some embodiments, the feeding belt conveyor 3 is arranged to be inclined upwardly by about 40°. Specifically, the feeding belt conveyor 3 may be arranged to be inclined upwardly by 40°±5°.

The crushing equipment 4 conveys the material toward the bottom material stirring equipment 10 through the upwardly inclined aggregate belt conveyor 6. Specifically, the construction waste is crushed by the crushing equipment 4 to form the aggregate, and the aggregate is conveyed inclinedly upward through the aggregate belt conveyor 6. Firstly, the aggregate is conveyed to an intermediate bin 7. A lower part of the intermediate bin 7 is provided with a discharge port. When the discharge port is opened, the aggregate can be allowed to enter the bottom material stirring equipment 10 below intermediate bin 7. The aggregate belt conveyor 6 can be arranged to be inclined at about 50°. Specifically, the aggregate belt conveyor 6 may be arranged to be inclined upwardly by 50°±5°. On the premise that the aggregate will not slide downward when being conveyed on the aggregate belt conveyor 6, a length of a downward projection of the aggregate belt conveyor 6 can be reduced as much as possible. The intermediate bin 7 and the bottom material stirring equipment 10 can be communicated through a flexible connection, for example, an expansion joint can be used to achieve the communication. In addition, the aggregate belt conveyor 6 can adopt a chain belt conveyor or a flat belt conveyor.

In addition, as a preferred embodiment, a vibrating screen 5 is further provided below an outlet of the crushing equipment 4. Through the screening of the vibrating screen 5, materials with a particle diameter larger than 10 mm are discharged from the discharge port of the vibrating screen 5, while the aggregate with a particle diameter smaller than 10 mm fall onto the aggregate belt conveyor 6. By using the vibrating screen 5, the crushed materials can be used directly without manual sorting and screening.

As shown in FIG. 22, the feeding belt conveyor 3 is a belt device that can be folded upward. Specifically, the feeding belt conveyor 3 may include three sections, and the feeding belt conveyor 3 is folded upward to form a roughly inverted U-shape, which can be disposed above the vehicle body 1. The arrangement of the upwardly folded feeding belt conveyor 3 on the vehicle body 1 needs to enable the height of the whole vehicle to conform to the road transportation conditions. Using the foldable belt conveyor can not only adjust the feeding angle, but also shorten the occupied space of the belt conveyor. In addition, as an alternative embodiment, the feeding belt conveyor 3 is omitted, in which case a bucket vehicle can be used for feeding.

The bottom material stirring equipment 10 conveys the material toward the brick making machine 17 through an upwardly inclined bottom material belt conveyor 11. Specifically, after the bottom material is fully stirred by the bottom material stirring equipment 10, the bottom material is conveyed inclinedly upward through the bottom material belt conveyor 11. Firstly, the bottom material is conveyed to a bottom material vehicle (i.e., a bottom material distribution vehicle) 16, and the bottom material vehicle 16 conveys the bottom material into the brick making machine 17 by moving. The inclination angle of the bottom material belt conveyor 11 may be arranged to about 50°. Specifically, the inclination angle of the bottom material belt conveyor 11 may be arranged to 50°±5°. On the premise that the bottom material will not slide downward during the conveying process on the belt conveyor, a length of a downward projection of the bottom material belt conveyor 11 should be reduced as much as possible. In addition, the bottom material belt conveyor 11 may also adopt a chain belt conveyor or a flat belt conveyor.

The surface material stirring equipment 14 conveys the surface material toward the brick making machine 17 through an upwardly inclined surface material belt conveyor 15. Specifically, after the surface material is fully stirred by the surface material stirring equipment 14, the surface material is conveyed inclinedly upward by the surface material belt conveyor 15. Firstly, the surface material is conveyed to a surface material vehicle (i.e., a surface material distribution vehicle) 18, and the surface material vehicle 18 conveys the surface material into the brick making machine 17 by moving. The inclination angle of the surface material belt conveyor 15 may be arranged to about 50°. Specifically, the inclination angle of the surface material belt conveyor 15 may be arranged to 50°±5°. On the premise that the surface material will not slide downward during the conveying process on the belt conveyor, a length of a downward projection of the surface material belt conveyor 15 should be reduced as much as possible. In addition, the surface material belt conveyor 15 can adopt a chain belt conveyor or a flat belt conveyor.

As shown in FIG. 23, the surface material stirring equipment 14 and the bottom material stirring equipment 10 are arranged along left and right sides in a length direction of the vehicle body 1. The brick making machine 17 is disposed at the same end of the vehicle body 1 as the surface material stirring equipment 14. The brick making machine 17 is fed through the bottom material vehicle 16 and the surface material vehicle 18, respectively. The bottom material vehicle 16 is configured to receive the bottom material conveyed by the bottom material belt conveyor 11, and then convey the bottom material into the brick making machine 17. The surface material vehicle 18 is configured to receive the surface material conveyed by the surface material belt conveyor 15, and then convey the surface material into the brick making machine 17.

As shown in FIGS. 21 to 23, the vehicle body 1 is provided with a cement bin 8. The cement bin 8 is disposed on the same side of the vehicle body 1 as the bottom material stirring equipment 10. The cement bin 8 is recessed downward on the vehicle body 1. The material is conveyed between the cement bin 8 and the bottom material stirring equipment 10 by an upwardly inclined cement screw conveyor 9. Specifically, the cement screw conveyor 9 is arranged to be inclined upward by about 50° (specifically, 50°±5°). The cement bin 8 can be configured to store black cement. The black cement is conveyed inclinedly upward to the bottom material stirring equipment 10 through the cement screw conveyor 9, so that the black cement and the aggregate are mixed and stirred evenly to form the bottom material for making bricks.

The vehicle body 1 is provided with a surface material bin 12. The surface material bin 12 is disposed on the same side of the vehicle body 1 as the surface material stirring equipment 14. The surface material bin 12 is recessed downward on the vehicle body 1. The surface material is conveyed between the surface material bin 12 and the surface material stirring equipment 14 by an upwardly inclined surface material screw conveyor 13. Specifically, the surface material screw machine 13 is arranged to be inclined upward by about 50° (specifically, 50°+5°). The surface material bin 12 is configured to store white cement and fine sand. The white cement and fine sand are conveyed inclinedly upward into the surface material stirring equipment 14 through the surface material screw conveyor 13, so that the white cement, the fine sand and a pigment are mixed and stirred evenly to form the surface material for making bricks.

As shown in FIG. 24, on the vehicle body 1, the feeding direction of the bottom material vehicle 16 for conveying the bottom material toward the brick making machine 17 is for conveying the material along a width direction of the vehicle body 1; the feeding direction of the surface material vehicle 18 for conveying the material toward the brick making machine 17 is for conveying the material along a length direction of the vehicle body 1. The feeding directions of the bottom material vehicle 16 and the surface material vehicle 18 are perpendicular to each other. With this layout, the length of the vehicle body 1 can be reduced, so that the vehicle body 1 can be more easily moved and turned around in a small area or on a narrow road. After the bottom material for brick making is conveyed to the bottom material vehicle 16 through the bottom material belt conveyor 11, after being evenly stirred, the bottom material is conveyed to the brick making machine 17 through the bottom material vehicle 16. In the brick making machine 17, after the bottom material is vibrated and compacted, the operation of arranging the bottom material into the mold is completed. At the same time, after the surface material is conveyed to the surface material vehicle 18 through the surface material belt conveyor 15, and after being evenly stirred, the surface material is conveyed to the brick making machine 17 through the surface material vehicle 18 to complete the operations of the arranging the surface material in the mold and cover an upper surface of the compacted bottom material, and the materials are formed into bricks after vibration, compaction and demolding.

A pallet feeder 19 may also be disposed below the surface material vehicle 18. The pallet feeder 19 is disposed on one side of the brick making machine 17, configured to convey the bricks with pallets to a palletizer 20. The palletizer 20 is disposed at a front end of the vehicle body 1. The palletizer 20 is configured to palletize the formed bricks to corresponding areas, so as to complete the whole process from construction waste to formed block bricks.

As shown in FIG. 23, the vehicle body 1 is provided with a hydraulic station 26, an electric control cabinet 24 and a control console 25. The hydraulic station 26, the electric control cabinet 24 and the control console 25 are configured to control the operation of equipment on the vehicle body 1. The equipment includes, but not limited to the feeding belt conveyor 3, the crushing equipment 4, the vibrating screen 5, the aggregate belt, the intermediate bin 7, the cement screw conveyor 9, the bottom material stirring equipment 10, the bottom material belt conveyor 11, the surface material screw conveyor 13, the surface material stirring equipment 14, the surface material belt conveyor 15, the bottom material vehicle 16, the surface material vehicle 18, the brick making machine 17, the pallet feeder 19, the palletizer 20 and hydraulic legs 21.

The hydraulic legs 21 are disposed below the vehicle body 1. The hydraulic station 26 provides the hydraulic power to drive the extension and retraction of the hydraulic legs 21 and the control thereof. The hydraulic legs 21 can support a front side and/or rear side of a vehicle chassis. In an embodiment, one pair of the hydraulic legs 21 are respectively provided on both sides of the front end, the rear end and the middle of the vehicle body 1. When working, the hydraulic legs 21 are supported on the ground, so that the tires of the vehicle are lifted off the ground, which can effectively improve the stability and safety of the whole machine.

A foldable ladder 22 and a foldable pedal 23 are further provided on both sides of the vehicle body 1, respectively. In a working state, the foldable ladder 22 and the foldable pedal 23 are unfolded. In a transporting state, the foldable ladder 22 and the foldable pedal 23 are folded to meet the maintenance requirements of the whole machine and meet the national road transportation conditions.

The integrated machine for crushing and brick making according to this embodiment, in which the brick making machine 17 and the crushing equipment 4 are integrated onto the same vehicle, have two functions of crushing the construction waste and automatically making bricks. The crushing and brick making processes do not require manual sorting, screening, handling and other processes, which realizes a fully automation of the whole process from the construction waste to the formed block bricks, realizing the recycling and reuse of the construction waste, and the entire production process is green and environmentally friendly. In addition, the vehicle can be designed to meet national road transport size requirements and can be allowed to travel on roads.

In the integrated machine for crushing and brick making according to this embodiment, each of the functional modules is mounted on the chassis of the vehicle independently, and has a high degree of interchangeability.

The integrated machine for crushing and brick making according to this embodiment has miniaturized size, enabling the size of the whole machine to meet the road transportation requirements, and has the function of self-propelled movement, can travel on the road, has improved maneuverability, and it is convenient to change sites, so that there is no need for additional equipment to assist in change sites.

The integrated machine for crushing and brick making according to this embodiment uses the bottom material formed by the mixture of the aggregate and the black cement and the surface material mixed with the white cement, the fine sand and the pigments, and conveys the bottom material and the surface material to the brick making machine 17, respectively, thereby avoiding the risk of the bottom material and the surface material sticking together, increasing the effectiveness of brick making.

As shown in FIGS. 21 to 23, the integrated machine for crushing and brick making according to an embodiment of the present disclosure further includes a tractor 27. The tractor 27 is connected to the vehicle body 1 of the integrated machine for crushing and brick makings. Specifically, the tractor 27 is connected to one end of the vehicle body 1 adjacent to the brick making machine 17. The tractor 27 is configured to pull the integrated machine for crushing and brick making, so that the integrated machine for crushing and brick making can be transferred in various areas in the community and at various construction sites, thereby avoiding the use of hoisting equipment for hoisting, and saving equipment costs.

In some embodiments, the vehicle body 1 may have a compartment that can be enclosed. Similar to the fixedly mounted brick making system 1000 as described above, the vehicle-mounted brick making system may also be provided with the dust collection device and/or the dust reduction device as described above.

According to some embodiments of the present disclosure, the material in the bottom material stirring equipment and the material in the surface material stirring equipment are respectively conveyed into the brick making machine through the bottom material vehicle and the surface material vehicle that are perpendicular to each other, so that the length of the vehicle body can be reduced. However, arranging the bottom material stirring equipment and the surface material stirring equipment separately on the left and right sides of the vehicle body and arranging the brick making machine at one end of the vehicle body or adjacent to the one end of the vehicle body can further reduce the length of the vehicle body. With this layout, the vehicle body can be moved and turned around more easily in the community.

According to some embodiments of the present disclosure, the bottom material stirring equipment is disposed in the concave area of the vehicle body, thereby reducing the height of the bottom material stirring equipment. When the upwardly inclined aggregate belt conveyor is used to convey the material toward the bottom material stirring equipment, the length of the aggregate belt conveyor can be reduced, thereby further reducing the length of the vehicle body as a whole.

According to some embodiments of the present disclosure, the inclination angle of the aggregate belt conveyor is set to 50° (specifically, 50°±5°), which can not only prevent the aggregate from sliding down on the belt conveyor, but also sets the length of the aggregate belt conveyor to be as short as possible, to minimize the length of the vehicle body.

It should be noted that, each of the modules in the above-mentioned embodiments may be a functional module or a program module, and may be implemented by software or hardware. For the modules implemented by hardware, the above-mentioned modules may be located in the same processor; or the above-mentioned modules may also be located in different processors in any combination,

An embodiment of the present disclosure further provides a computer device, and the production control method according to the embodiments of the present disclosure can be implemented by the computer device. The computer device in the embodiment of the present disclosure includes, but is not limited to, a memory, a processor, and a computer program stored on the memory and executable on the processor. The processor implements the production control methods in the above embodiments when executing the computer program.

An embodiment of the present disclosure further provides a computer-readable storage medium. Computer program instructions are stored on the computer-readable storage medium. When the computer program instructions are executed by a processor, any one of the production control methods according to the foregoing embodiments is implemented.

It can be understood that, the same or similar parts in the above embodiments may be referred to each other, and the content not described in detail in some embodiments may refer to the same or similar content in other embodiments.

It should be noted that, in the description of the present disclosure, terms “first”, “second”, etc. are only used for description, and should not be construed as indicating or implying relative importance. It is also to be understood that orientation or positional relationships indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial” ,“radial”, “circumferential”, etc. are based on orientation or positional relationship shown in the drawings, which are merely to facilitate the description of the present application and simplify the description, not to indicate or imply that the device or elements must have a particular orientation, be constructed and operated in a particular orientation, and therefore cannot be construed as a limitation on the present application. In addition, in the description of the present disclosure, unless otherwise specified, the meanings of “plurality” and “multiple” refer to at least two.

In the description of this disclosure, it should be noted that, unless expressly specified and limited otherwise, the terms “mounting”, “connecting”, and “connected” should be understood in a broad sense; for example, it may be a fixed connection or a detachable connection, or an integration, may be a mechanical connection or electrical connection, may be a direct connection, or may be an indirect connection through an intermediate medium, may be the connection between two elements. For example, when an element is referred to as being “fixed to” or “disposed to” another element, it can be directly on another element or an intermediate element may also be present; when an element is referred to as being “connected to” another element, it may be directly connected to another element or an intermediate element may be present at the same time. In addition, when involving to the field of communication, the “connection” used herein may include a wired connection or a wireless connection. In addition, as used in this disclosure, the term “and/or” includes any and all combinations of one or more of the associated listed items. For those of ordinary skill in the art, the specific meanings of the above terms in this disclosure can be understood in specific situations.

Any process or method description in the flowcharts or otherwise described herein may be understood to represent a module, segment or portion of code comprising one or more executable instructions for implementing a particular function or step of the process. The scope of the preferred embodiments of the present disclosure includes alternative implementations in which the functions may be performed out of the order shown or discussed, including performing the functions substantially concurrently or in the reverse order depending upon the functions involved, which should be understood by those skilled in the art to which the embodiments of the present disclosure belong.

It should be understood that various parts of this disclosure may be implemented in hardware, software, firmware, or a combination thereof. In the above-described embodiments, various steps or methods may be implemented in software or firmware stored in a memory and executed by a suitable instruction execution system. For example, if implemented in hardware, as in another embodiment, it can be implemented by any one or a combination of the following techniques known in the art: discrete logic circuits with logic gates for implementing logic functions on data signals, application specific integrated circuits with suitable combinational logic gates, programmable gate arrays (PGA), field programmable gate arrays (FPGA), etc.

Those of ordinary skill in the art can understand that all or part of the steps carried by the methods of the above embodiments can be completed by instructing the relevant hardware through a program, and the program can be stored in a computer-readable storage medium. When executed, one or a combination of the steps of the methods of the embodiments is performed.

In addition, each of the functional units in the embodiments of the present disclosure may be integrated into one processing module, or each of the units may exist physically alone, or two or more of the units may be integrated into one module. The above-mentioned integrated modules can be implemented in a form of hardware, and can also be implemented in a form of software function module. If the integrated modules are implemented in the form of software functional module and sold or used as independent products, they may also be stored in a computer-readable storage medium.

The above-mentioned computer-readable storage medium may be a read-only memory, a magnetic disk or an optical disk, and the like.

In the description of this specification, descriptions with reference to the terms “one embodiment”, “some embodiments”, “example”, “specific example”, or “some examples” etc., mean that specific features, structures, materials or features described in connection with the embodiment or example, are included in at least one of the embodiments or examples of the present disclosure. In this specification, schematic representations of the above terms do not necessarily refer to the same embodiment or example. Furthermore, the specific features, structures, materials or features as described above may be combined in any suitable manner in any one or more of the embodiments or examples.

Although the embodiments of the present disclosure have been shown and described above, it should be understood that the above embodiments are exemplary and should not be construed as limitations to the present disclosure. Variations, modifications, substitutions and variations may be made to the above embodiments by a person of ordinary skills in the art, within the scope of the present application. For example, the technical features involved in the different embodiments of the present disclosure as described above can be combined with each other as long as they do not conflict with each other.

1-36. (canceled)

37. A production control method, applied in a production system comprising at least two robots with different production functions, wherein the production control method comprises:
obtaining an initial position of each of the at least two robots and a target position in a production process of each of the at least two robots; and
planning a working path of each of the at least two robots according to the initial position and the target position of each of the at least two robots, and respectively controlling a corresponding robot of the at least two robots to work based on a working sequence and the working path of each of the at least two robots.

38. The production control method according to claim 37, wherein the respectively controlling the corresponding robot to work based on the working sequence and the working path of each of the robots comprises:
determining an initial working time of each of the at least two robots based on the working sequence and a working duration of each of the at least two robots; and
respectively controlling the corresponding robot to work based on the initial working time of each of the robots and the working path corresponding to the initial working time.

39. The production control method according to claim 37, wherein the respectively controlling the corresponding robot to work based on the working sequence and the working path of each of the robots comprises:
in response to receiving work completion information of a robot of the at least two robots in current procedure, sending the working path to a robot of the at least two robots in next procedure to control the robot in the next procedure to start working; or
respectively sending each of working paths to the corresponding robot, and in response to receiving work completion information of the robot in current procedure, sending a work start instruction to the robot in next procedure.

40. The production control method according to claim 37, wherein the obtaining the initial position of each of the robots and the target position in the production process of each of the robots comprises:
obtaining a production task, and determining robots configured to perform the production task according to the production task;
obtaining the initial position of each of the determined robots, and prior to performing the production task, determining the target position of each of the determined robots according to the production task;
wherein a working mode of each of the robots is determined according to the production task after determining the robots configured to perform the production task according to the production task.

41. The production control method according to claim 37, wherein the robots comprise a production line robot and at least one feeding robot; wherein,
the working path of the production line robot is planned based on the initial position of the production line robot and a storage position of production raw material; and
the working path of the feeding robot is planned based on the initial position and a material taking position of the feeding robot, and a target position in the planned working path of the production line robot.

42. The production control method according to claim 37, wherein the robots further comprise at least one of a transfer robot, a palletizing robot, a packaging robot, a finished product transfer robot, and a loading robot, wherein,
the working path of the at least one of the transfer robot, the palletizing robot, the packaging robot, the finished product transfer robot, and the loading robot is generated based on the initial position, and a starting position and an ending position in the target position of the at least one of the transfer robot, the palletizing robot, the packaging robot, the finished product transfer robot, and the loading robot.

43. The production control method according to claim 37, wherein the robot comprises at least one of a control module, a positioning module, a detection module, and a path correction module, wherein,
the control module is configured to receive the working path of the robot, and control the robot to work according to the working path;
the positioning module is configured to obtain the initial position of the robot and a real-time position during a working process of the robot;
the detection module is configured to detect whether there is an obstacle in the working path during the working process of the robot; and
the path correction module is configured to control the robot to always move along the working path.

44. A brick making system, comprising:
a brick making machine;
a bottom material distribution device connected to one side of the brick making machine to feed bottom material to the brick making machine in a first direction; and
a surface material distribution device connected to the other side of the brick making machine adjacent to the one side, to feed surface material to the brick making machine in a second direction.

45. The brick making system according to claim 44, further comprising:
a first feeding device configured to convey pallets; and
a second feeding device configured to convey the pallets, and wherein the second feeding device is located downstream of the first feeding device, and a conveying direction of the second feeding device forms a predetermined angle with a conveying direction of the first feeding device; the predetermined angle is in a range of 60 degrees and 120 degrees;
wherein the surface material distribution device or the bottom material distribution device is disposed on the second feeding device, and is formed integrally with the second feeding device; and
wherein the brick making machine is disposed downstream of the second feeding device.

46. The brick making system according to claim 45, wherein the first feeding device is provided with a pallet pushing mechanism configured to push the pallets; the first feeding device comprises:
a first supporting frame configured to support a plurality of pallets that are stacked;
a foldable feeding holder hinged with the first supporting frame;
a limiting structure configured to limit the pallets and comprising a first limiting structure and a second limiting structure; the first limiting structure being disposed on the foldable feeding holder; the second limiting structure being disposed on the first supporting frame;
a pallet aligning structure configured to organize and align the pallets;
a pallet conveying cylinder disposed at a bottom of the first supporting frame, configured to push a bottommost pallet to the pallet aligning structure; and
a guide structure disposed on the first supporting frame and configured to guide the aligned pallets;
wherein the pallet conveying cylinder conveys the aligned pallets to the second feeding device.

47. The brick making system according to claim 44, wherein the pallet aligning structure comprises:
a frame body;
a pallet aligning cylinder configured to drive the pallet aligning structure to organize and align the pallets;
an alignment connecting rod hinged with the pallet aligning cylinder and comprising a first alignment connecting rod and a second alignment connecting rod; one end of the first alignment connecting rod being connected to one end of the second alignment connecting rod, and the one end of the first alignment connecting rod and the one end of the second alignment connecting rod being hinged with the pallet aligning cylinder, respectively; and
a pallet clamping rod hinged with the frame body, comprising a first pallet clamping rod and a second pallet clamping rod; the other end of the first alignment connecting rod being hinged with the first pallet clamping rod, and the other end of the second alignment connecting rod being hinged with the second pallet clamping rod.

48. The brick making system according to claim 45, wherein the conveying direction of the second feeding device is substantially perpendicular to the conveying direction of the first feeding device; and the second feeding device comprises:
a first conveying mechanism;
a second supporting frame; and
a driving mechanism comprising a driving motor; and wherein the driving motor in driving connection with the first conveying mechanism, to drive the first conveying mechanism to convey the pallet onto a vibrating stand of the brick making machine.

49. The brick making system according to claim 48, wherein the surface material distribution device comprises:
a third supporting frame disposed above the second supporting frame;
a surface material distribution vehicle disposed on the third supporting frame, and having an adjustable height;
a surface material hopper comprising a supporting wheel;
a hopper guide member configured to guide the surface material hopper; and
a hopper driving hydraulic cylinder connected to the surface material hopper to drive the surface material hopper to reciprocate.

50. The brick making system according to claim 49, wherein the surface material distribution device further comprises a height adjusting mechanism; the height adjusting mechanism is configured to adjust a height of the surface material distribution vehicle and comprises:
a vertical guide shaft for surface material vehicle configured to adjust the height of the surface material distribution vehicle; and
a supporting screw for surface material vehicle comprising an upper end connected to the surface material distribution vehicle, and a lower end connected to the second supporting frame; and the supporting screw for surface material vehicle being locked by a nut at both ends.

51. The brick making system according to claim 44, wherein the brick making machine comprises a mold frame, a pressing head disposed above the mold frame, and a vibrating stand disposed below the mold frame; and/or the bottom material distribution device comprises a double oil cylinder connecting rod structure, so that the bottom material distribution device distributes material into the brick making machine reciprocally.

52. The brick making system according to claim 44, wherein the brick making machine comprises:
a machine supporting guide shaft;
a machine supporting upper plate disposed on a top of the machine supporting guide shaft;
a pressing head guiding fixing seat connected to the machine supporting guide shaft and located below the machine supporting upper plate;
a pressing head detachably disposed on the pressing head guiding fixing seat;
a pressing head lifting hydraulic cylinder configured to drive the pressing head to raise and lower;
a machine supporting lower plate disposed at a bottom of the machine supporting guide shaft;
a vibrating stand disposed on the machine supporting lower plate;
a frame guiding fixing seat connected to the machine supporting guide shaft, and located above the machine supporting lower plate;
a mold frame detachably connected to the frame guiding fixing seat;
a frame lifting hydraulic cylinder configured to drive the mold frame to raise and lower; and
a connecting rod disposed between the machine supporting lower plate and the frame guiding fixing seat.

53. The brick making system according to claim 44, further comprising a fixed or movable mounting platform; wherein the brick making machine is arranged on an end of the mounting platform; the movable platform is a tractor, trailer, semi-trailer or flatbed.

54. The brick making system according to claim 44, further comprising:
a movable vehicle body, on which a crushing equipment, a bottom material stirring equipment, a surface material stirring equipment, the bottom material distribution device, the surface material distribution device, and the brick making machine and/or a brick discharging platform are provided;
wherein an aggregate belt conveyor conveys material between the crushing equipment and the bottom material stirring equipment; a bottom material belt conveyor conveys the material between the bottom material stirring equipment and the brick making machine; a surface material belt conveyor conveys the material between the surface material stirring equipment and the brick making machine;
wherein the surface material stirring equipment and the bottom material stirring equipment are arranged at two sides of a vehicle body in a length direction of the vehicle body; the bottom material distribution device receives bottom material conveyed by the bottom material belt conveyor; the surface material distribution device receives surface material conveyed by the surface material belt conveyor.

55. The brick making system according to claim 54, wherein the vehicle body is provided with a cement bin; the cement bin is recessed downward on the vehicle body; the material is conveyed between the cement bin and the bottom material stirring equipment by an upwardly inclined cement screw conveyor;
wherein the cement bin is disposed on the same side of the vehicle body as the bottom material stirring equipment.

56. The brick making system according to claim 54, wherein the vehicle body is provided with a surface material bin; the surface material bin is recessed downward on the vehicle body; the material is conveyed between the surface material bin and the surface material stirring equipment by an upwardly inclined surface material screw conveyor;
wherein the surface material bin is disposed on the same side of the vehicle body as the surface material stirring equipment.
